(19) United States
(12) Patent Application Publication
(10) Pub. No.: US 2015/0016503 A1
(43) Pub. Date: Jan. 15, 2015

(54) TILES AND WAVEFRONT PROCESSING IN MULTI-LAYER CONTEXT

(71) Applicant: QUALCOMM Incorporated, San Diego, CA (US)

(72) Inventors: Krishnakanth Rapaka, San Diego, CA (US); Ye-Kui Wang, San Diego, CA (US)

(21) Appl. No.: 14/331,054

(22) Filed: Jul. 14, 2014

Related U.S. Application Data
(60) Provisional application No. 61/846,500, filed on Jul. 15, 2013.

(51) Int. Cl. H04N 19/159; H04N 19/187; H04N 19/105

(52) U.S. Cl. CPC H04N 19/00218; H04N 19/00024; H04N 19/00321
USPC 375/240.02

(57) ABSTRACT

A video encoder may generate a bitstream that includes a syntax element that indicates whether inter-layer prediction is enabled for decoding a tile of a picture of the video data. Similarly, a video decoder may obtain, from a bitstream, a syntax element that indicates whether inter-layer prediction is enabled. The video decoder may determine, based on the syntax element, whether inter-layer prediction is enabled for decoding a tile of a picture of the video data, and decode the tile based on the determination.

This application claims the benefit of U.S. Provisional Patent Application No. 61/846,500, filed Jul. 15, 2013, the entire content of which is incorporated herein by reference.

### TECHNICAL FIELD

This disclosure relates to video coding (i.e., encoding and/or decoding of video data).

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicates the difference between the coded block and the predictive block. An intra-coded block is encoded according to an intra-coding mode and the residual data. For further compression, the residual data may be transformed from the pixel domain to a transform domain, resulting in residual coefficients, which then may be quantized. The quantized coefficients, initially arranged in a two-dimensional array, may be scanned in order to produce a one-dimensional vector of coefficients, and entropy coding may be applied to achieve even more compression.

### SUMMARY

In general, this disclosure relates to multi-layer or multi-view video coding. More specifically, a video encoder may generate a bitstream that includes a syntax element that indicates whether inter-layer prediction is enabled for decoding video data in a tile of a picture of the video data. In other words, a video coder may generate a bitstream that includes a syntax element that indicates that no prediction block in a tile is predicted from an inter-layer reference picture. Similarly, a video decoder may obtain the syntax element from the bitstream. The video decoder may determine, based on the syntax element, whether inter-layer prediction is enabled for decoding video data in a tile of a picture of the video data.

In another example, this disclosure describes a method for decoding video data, the method comprising: obtaining, from a bitstream, a syntax element; determining, based on the syntax element, whether inter-layer prediction is enabled for decoding a tile of a picture of the video data, wherein the picture is partitioned into a plurality of tiles and the picture is not in a base layer; and decoding the tile.

In another example, this disclosure describes a method for encoding video data, the method comprising: generating a bitstream that includes a syntax element that indicates whether inter-layer prediction is enabled for decoding a tile of a picture of the video data, wherein the picture is partitioned into a plurality of tiles and the picture is not in a base layer; and outputting the bitstream

In another example, this disclosure describes a video decoding device comprising: a computer-readable medium configured to store video data; and one or more processors configured to: obtain, from a bitstream, a syntax element; determine, based on the syntax element, whether inter-layer prediction is enabled for decoding a tile of a picture of the video data, wherein the picture is partitioned into a plurality of tiles and the picture is not in a base layer; and decode the tile.

In another example, this disclosure describes a video encoding device comprising: a computer-readable medium configured to store video data; and one or more processors configured to: generate a bitstream that includes a syntax element that indicates whether inter-layer prediction is enabled for decoding a tile of a picture of the video data, wherein the picture is partitioned into a plurality of tiles and the picture is not in a base layer; and output the bitstream.

In another example, this disclosure describes a video decoding device comprising: means for obtaining, from a bitstream, a syntax element; means for determining, based on the syntax element, whether inter-layer prediction is enabled for decoding a tile of a picture of video data, wherein the picture is partitioned into a plurality of tiles and the picture is not in a base layer; and means for decoding the tile.

In another example, this disclosure describes a video encoding device comprising: means for generating a bitstream that includes a syntax element that indicates whether inter-layer prediction is enabled for decoding a tile of a picture of video data, wherein the picture is partitioned into a plurality of tiles and the picture is not in a base layer; and means for outputting the bitstream.

In another example, this disclosure describes a computer-readable data storage medium (e.g., a non-transitory computer-readable data storage medium) having instructions stored thereon that, when executed, cause one or more processors to: obtain, from a bitstream, a syntax element; determine, based on the syntax element, whether inter-layer prediction is enabled for decoding a tile of a picture of video data, wherein the picture is partitioned into a plurality of tiles and the picture is not in a base layer; and decode the tile.

In another example, this disclosure describes a computer-readable data storage medium having instructions stored thereon that, when executed, cause one or more processors to: generate a bitstream that includes a syntax element that indicates whether inter-layer prediction is enabled for decoding a tile of a picture of video data, wherein the picture is partitioned into a plurality of tiles and the picture is not in a base layer; and output the bitstream.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video coding system that may utilize the techniques described in this disclosure.

FIG. 2 is a conceptual diagram illustrating an example raster scan of a picture when tiles are used.

FIG. 3 is a conceptual diagram illustrating an example of wavefront parallel processing of a picture.

FIG. 4A is a conceptual diagram illustrating an example raster scan order of coding tree units (CTUs) in an enhancement layer picture having four tiles.

FIG. 4B is a conceptual diagram illustrating an example raster scan order of CTUs in a base layer picture corresponding to the enhancement layer picture of FIG. 4A.

FIG. 5A is a conceptual diagram illustrating an example coding tree block (CTB) order in a bitstream when each tile is written to the bitstream in sequential order according to tile identification in increasing order.

FIG. 5B is a conceptual diagram illustrating an example CTB order in a bitstream when tiles are not written to the bitstream in sequential order according to tile identification in increasing order.

FIG. 6 is a block diagram illustrating an example video encoder that may implement the techniques described in this disclosure.

FIG. 7 is a block diagram illustrating an example video decoder that may implement the techniques described in this disclosure.

FIG. 8A is a flowchart illustrating an example operation of a video encoder, in accordance with one or more techniques of this disclosure.

FIG. 8B is a flowchart illustrating an example operation of a video decoder, in accordance with one or more techniques of this disclosure.

FIG. 9A is a flowchart illustrating an example operation of a video encoder, in accordance with one or more techniques of this disclosure.

FIG. 9B is a flowchart illustrating an example operation of a video decoder, in accordance with one or more techniques of this disclosure.

FIG. 10A is a flowchart illustrating an example operation of a video encoder, in accordance with one or more techniques of this disclosure.

FIG. 10B is a flowchart illustrating an example operation of a video decoder, in accordance with one or more techniques of this disclosure.

FIG. 11A is a flowchart illustrating an example operation of a video encoder, in accordance with one or more techniques of this disclosure.

FIG. 11B is a flowchart illustrating an example operation of a video decoder, in accordance with one or more techniques of this disclosure.

### DETAILED DESCRIPTION

Some video coding standards, such as High Efficiency Video Coding (HEVC) implement tiles. A picture may include one or more tiles. In other words, a picture may be partitioned into one or more tiles. In at least some examples, a tile is an integer number of blocks (e.g., coding tree blocks (“CTBs”) in one column and one row, ordered consecutively in a block (e.g., CTB) raster scan of the tile. The tiles of a picture may be coded consecutively in a tile raster scan of the picture.

The use of tiles may improve coding efficiency because tiles allow picture partition shapes that contain samples with potential higher correlation than slices. In addition, the use of tiles may improve coding efficiency because tiles may reduce slice overhead. Furthermore, in some instances, a video encoder may be configured to encode a picture such that each tile of the picture can be decoded independently of each other tile of the picture. Thus, a video coder may be able to code the tiles of a picture in parallel.

Furthermore, some video coding standards or their extensions implement multi-layer coding. For instance, the multi-view, 3-dimensional (3D) video coding, and scalable video coding extensions of HEVC implement multi-layer coding. In multi-view and 3D video coding, each of the layers corresponds to a different view. In scalable video coding, the layers may include a base layer and one or more enhancement layers. The base layer may include basic video data. The enhancement layers may include additional information to enhance the visual quality of the video data.

In general, there is significant redundancy between corresponding pictures in different layers. For example, in multi-view coding and 3D video coding, there may be significant visual similarity between pictures that are in different views (e.g., captured from different viewpoints) but are in the same time instance. Inter-layer prediction exploits the redundancies between pictures in different layers to reduce the overall amount of data representing the pictures. However, the use of inter-layer prediction introduces dependencies between pictures in different layers. For this reason, encoding and decoding a picture based on information of a picture in a different layer (i.e., using inter-layer prediction to encode the picture) may prevent the pictures from being decoded in parallel. Decoding pictures in parallel may reduce the amount of time needed to decode the pictures.

When a video decoder is preparing to decode a tile of a picture, the video decoder may need to determine whether the video decoder can decode the tile in parallel with other tiles. For instance, the video decoder may need to be able to determine whether the tile can be decoded in parallel with a corresponding tile in a picture belonging to a different layer. In some examples, a corresponding tile in a picture belonging to a different layer (i.e., an inter-layer reference picture) is a co-located tile (i.e., a tile co-located with the tile currently being coded). To determine whether the tile can be decoded in parallel with a corresponding tile in a different layer, the video decoder may need to be able to determine whether the tile is encoded using inter-layer prediction. However, it is currently not possible for the video decoder to determine whether a tile is encoded using inter-layer prediction without decoding the tile.

One or more techniques of this disclosure may address such issues. That is, one or more of the techniques of this disclosure may serve to enable a video decoder to determine whether a tile is encoded using inter-layer prediction. For example, a video decoder may obtain, from a bitstream, a syntax element. The video decoder may determine, based on the syntax element, whether inter-layer prediction is enabled for decoding a tile of a picture of the video data. In this example, the tile is not in a base layer and the tile may be one of a plurality of tiles of the picture. The plurality of tiles of the picture may be referred to herein as a tile set. Some or all techniques of this disclosure that apply to individual tiles may also apply to tile sets that comprise multiple tiles. In another example, a video encoder may generate a bitstream that includes a syntax element that indicates whether inter-layer prediction is enabled for decoding a tile of a picture of the video data. The video encoder may output the bitstream.

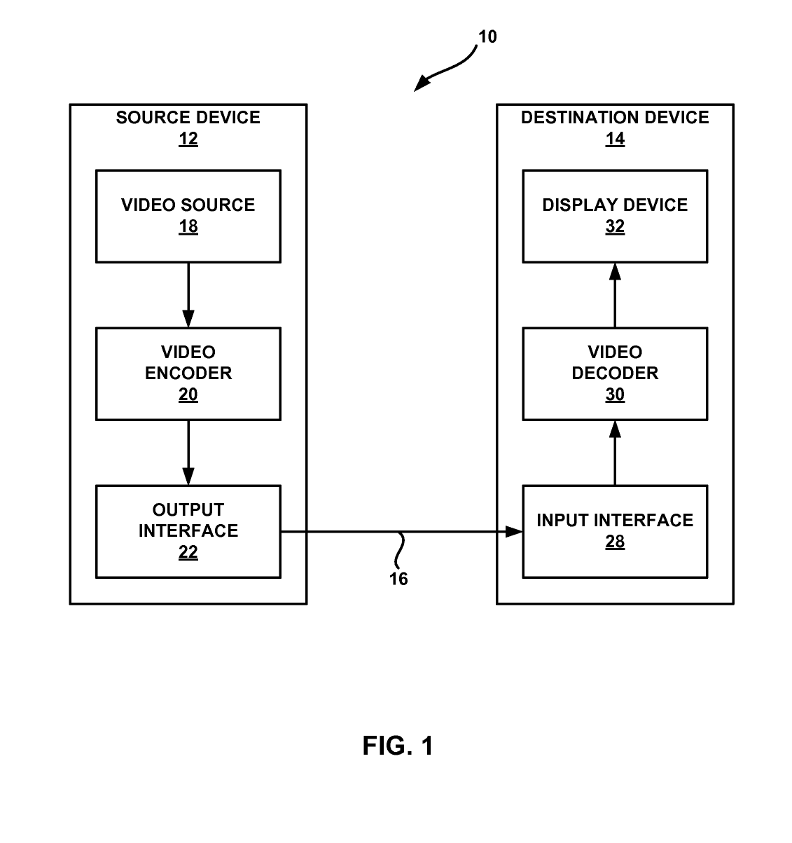

FIG. 1 is a block diagram illustrating an example video coding system 10 that may utilize the techniques of this disclosure. As used herein, the term “video coder” refers generically to both video encoders and video decoders. In this disclosure, the terms “video coding” or “coding” may refer generically to video encoding or video decoding.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium, e.g., via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

FIG. 1 is merely an example and the techniques of this disclosure may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In many examples, the encoding and decoding is performed by devices that do not communicate with one another, but simply encode data to memory and/or retrieve and decode data from memory.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device, e.g., a video camera, a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

Video encoder 20 and video decoder 30 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof. If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” certain information to another device, such as video decoder 30. The term “signaling” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium in an encoded bitstream at the time of encoding, which then may be retrieved by a decoding device at any time after being stored to this medium.

In some examples, video encoder 20 and video decoder 30 operate according to a video compression standard, such as ISO/IEC MPEG-4 Visual and ITU-T H.264 (also known as ISO/IEC MPEG-4 AVC), including its Scalable Video Coding (SVC) extension, Multiview Video Coding (MVC) extension, and MVC-based three-dimensional video (3DV) extension. In some instances, any legal bitstream conforming to MVC-based 3DV always contains a sub-bitstream that is compliant to a MVC profile, e.g., stereo high profile. Furthermore, there is an ongoing effort to generate a 3DV coding extension to H.264/AVC, namely AVC-based 3DV. In other examples, video encoder 20 and video decoder 30 may operate according to ITU-T H.261, ISO/IEC MPEG-1 Visual, ITU-T H.262 or ISO/IEC MPEG-2 Visual, ITU-T H.263, ISO/IEC MPEG-4 Visual, and ITU-T H.264, ISO/IEC Visual. Thus, the video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In the example of FIG. 1, video encoder 20 and video decoder 30 may operate according to the High Efficiency Video Coding (HEVC) standard developed by the Joint Collaboration Team on Video Coding (JCT-VC) of ITU-T Video Coding Experts Group (VCEG) and ISO/IEC Motion Picture Experts Group (MPEG). A draft of the HEVC standard, referred to as “HEVC Working Draft 10” is described in Bross et al., “High Efficiency Video Coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12^{th} Meeting, Geneva, Switzerland, January 2013. Another HEVC text specification draft, referred to as HEVC WD10 for simplicity, is available as of Jul. 15, 2013 from http://phenix.int-evey.fr/jct/doc_end_user/documents/13_Incheon/wg11/JCTVC-M0432-v3.zip, the entire content of which is incorporated by reference. Newer versions of the HEVC standard are also available.

Furthermore, there are ongoing efforts to produce scalable video coding, multi-view coding, and 3DV extensions for HEVC. The scalable video coding extension of HEVC may be referred to as HEVC-SVC or SHEVC. The multi-view coding extension of HEVC may be referred to as MV-HEVC. The 3DV extension of HEVC may be referred to as HEVC-based 3DV or 3D-HEVC. A recent Working Draft (WD) of MV-HEVC WD 4 hereinafter from http://phenix.int-evey.fr/jct2/doc_end_user/documents/4_Incheon/wg11/JCT3V-D1004-v2.zip, the entire content of which is incorporated by reference. Meanwhile, two standard tracks for more advanced 3D video coding (3D-HEVC) and scalable video coding based on HEVC (SHEVC) are also under development. A test model description of 3D-HEVC is available from http://phenix.it-sudparis.eu/jct2/doc_end_user/documents/3_Geneva/wg11/JCT3V-D1005-v2.zip, the entire content of which is incorporated by reference. A test model description of SHVC is available from http://phenix.int-evey.fr/jct/doc_end_user/documents/12_Geneva/wg11/JCTVC-M1007-v3.zip, the entire content of which is incorporated by reference.

In HEVC and other video coding standards, a video sequence typically includes a series of pictures. Pictures may also be referred to as “frames.” A picture may include three sample arrays, denoted S_{L}, S_{Cb}, and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

Video encoder 20 may generate a set of coding tree units (CTUs). Each of the CTUs may comprise a coding tree block (CTB) of luma samples, two corresponding coding tree blocks of chroma samples, and syntax structures used to code the samples of the coding tree blocks. In a monochrome picture or a picture that has three separate color planes, a CTU may comprise a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other video coding standards, such as H.264/AVC. However, a CTU is not necessarily limited to a particular size and may include one or more coding units (CUs). A slice may include an integer number of CTUs ordered consecutively in a scanning order (e.g., a raster scanning order).

This disclosure may use the term “video unit,” “video block,” or simply “block” to refer to one or more blocks of samples and syntax structures used to code samples of the one or more blocks of samples. Example types of video units may include CTUs, CUs, PUs, transform units (TUs), macroblocks, macroblock partitions, and so on.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that has three separate color planes, a CU may comprise a single coding block and syntax structures used to code the samples of the coding block.

Video encoder 20 may partition a coding block of a CU into one or more prediction blocks. A prediction block may be a rectangular (i.e., square or non-square) block of samples on which the same prediction is applied. A prediction unit (PU) of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples. Video encoder 20 may generate predictive luma, Cb and Cr blocks for luma, Cb and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Inter prediction may be uni-directional inter prediction (i.e., uni-prediction) or bi-directional inter prediction (i.e., bi-prediction). To perform uni-prediction or bi-prediction, video encoder 20 may generate a first reference picture list (RefPicList0) and a second reference picture list (RefPicList1) for a current slice. Each of the reference picture lists may include one or more reference pictures.

When using uni-prediction, video encoder 20 may search the reference pictures in either or both RefPicList0 and RefPicList1 to determine a reference location within a reference picture. Furthermore, when using uni-prediction, video encoder 20 may generate, based at least in part on samples corresponding to the reference location, the predictive sample blocks for the PU. Moreover, when using uni-prediction, video encoder 20 may generate a single motion vector that indicates a spatial displacement between a prediction block of the PU and the reference location. To indicate the spatial displacement between a prediction block of the PU and the reference location, a motion vector may include a horizontal component specifying a horizontal displacement between the prediction block of the PU and the reference location and may include a vertical component specifying a vertical displacement between the prediction block of the PU and the reference location.

When using bi-prediction to encode a PU, video encoder 20 may determine a first reference location in a reference picture in RefPicList0 and a second reference location in a reference picture in RefPicList1. Video encoder 20 may then generate, based at least in part on samples corresponding to the first and second reference locations, the predictive blocks for the PU. Moreover, when using bi-prediction to encode the PU, video encoder 20 may generate a first motion vector indicating a spatial displacement between a sample block of the PU and the first reference location and a second motion vector indicating a spatial displacement between the prediction block of the PU and the second reference location.

After video encoder 20 generates predictive blocks (e.g., predictive luma, Cb, and Cr blocks) for one or more PUs of a CU, video encoder 20 may generate a residual block for the CU. Each sample in the residual block indicates a difference between a sample in one of the CU's predictive blocks and a corresponding sample in one of the CU's original coding blocks. For example, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the residual blocks (e.g., luma, Cb and, Cr residual blocks) of a CU into one or more transform blocks (e.g., luma, Cb, and Cr transform blocks). A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that have three separate color planes, a TU may comprise a single transform block and syntax structures used to transform the transform block samples. Thus, each TU of a CU may correspond to (i.e., be associated with) a luma transform block, a Cb transform block, and a Cr transform block. The luma transform block corresponding to (i.e., associated with) the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a transform block of a TU to generate a coefficient block for the TU. A coefficient block may be a two-dimensional array of transform coefficients. A transform coefficient may be a scalar quantity. For example, video encoder 20 may apply one or more transforms to a luma transform block of a TU to generate a luma coefficient block for the TU. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. Furthermore, video encoder 20 may inverse quantize transform coefficients and may apply an inverse transform to the transform coefficients in order to reconstruct transform blocks of TUs of CUs of a picture. Video encoder 20 may use the reconstructed transform blocks of TUs of a CU and the predictive blocks of PUs of the CU to reconstruct coding blocks of the CU. By reconstructing the coding blocks of each CU of a picture, video encoder 20 may reconstruct the picture. Video encoder 20 may store reconstructed pictures in a decoded picture buffer (DPB). Video encoder 20 may use reconstructed pictures in the DPB for inter prediction and intra prediction.

After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream.

Video encoder 20 may output a bitstream that includes a sequence of bits that forms a representation of coded pictures and associated data. The bitstream may comprise a sequence of network abstraction layer (NAL) units. Each of the NAL units includes a NAL unit header and encapsulates a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a picture parameter set (PPS), a second type of NAL unit may encapsulate an RBSP for a coded slice, a third type of NAL unit may encapsulate an RBSP for Supplemental Enhancement Information (SEI), and so on. A PPS is a syntax structure that may contain syntax elements that apply to zero or more entire coded pictures. NAL units that encapsulate RBSPs for video coding data (as opposed to RBSPs for parameter sets and SEI messages) may be referred to as video coding layer (VCL) NAL units. A NAL unit that encapsulates a coded slice may be referred to herein as a coded slice NAL unit. An RBSP for a coded slice may include a slice header and slice data. A slice header may include data regarding a slice. The slice data of a slice may include coded representations of blocks of the slice. In general, SEI contains information that is not necessary to decode the samples of coded pictures from VCL NAL units. An SEI RBSP contains one or more SEI messages.

HEVC and other video coding standards provide for various types of parameter sets. For example, a video parameter set (VPS) is a syntax structure comprising syntax elements that apply to zero or more entire coded video sequences (CVSs). A sequence parameter set (SPS) may contain information that applies to all slices of a CVS. An SPS may include a syntax element that identifies a VPS that is active when the SPS is active. Thus, the syntax elements of a VPS may be more generally applicable than the syntax elements of an SPS. A PPS is a syntax structure comprising syntax elements that apply to zero or more coded pictures. A PPS may include a syntax element that identifies an SPS that is active when the PPS is active. A slice header of a slice may include a syntax element that indicates a PPS that is active when the slice is being coded.

Video decoder 30 may receive a bitstream. In addition, video decoder 30 may parse the bitstream to obtain (e.g., decode) syntax elements from the bitstream. Video decoder 30 may reconstruct the pictures of the video data based at least in part on the syntax elements decoded from the bitstream. The process to reconstruct the video data may be generally reciprocal to the process performed by video encoder 20. For instance, video decoder 30 may use motion vectors of PUs to determine predictive blocks for the PUs of a current CU.

In addition, video decoder 30 may inverse quantize coefficient blocks associated with TUs of the current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive sample blocks (i.e., predictive blocks) for PUs of the current CU to corresponding samples of the transform blocks of the TUs of the current CU. By reconstructing the coding blocks for each CU of a picture, video decoder 30 may reconstruct the picture. Video decoder 30 may store decoded pictures in a decoded picture buffer for output and/or for use in decoding other pictures.

In MV-HEVC, 3D-HEVC and SHEVC, a video encoder may generate a bitstream that comprises a series of NAL units. Different NAL units of the bitstream may be associated with different layers of the bitstream. A layer may be defined as a set of VCL NAL units and associated non-VCL NAL units that have the same layer identifier. A layer may be equivalent to a view in multi-view video coding. In multi-view video coding, a layer can contain all view components of the same layer with different time instances. Each view component may be a coded picture of the video scene belonging to a specific view at a specific time instance. In some examples of 3D video coding, a layer may contain either all coded depth pictures of a specific view or coded texture pictures of a specific view. In other examples of 3D video coding, a layer may contain both texture view components and depth view components of a specific view. Similarly, in the context of scalable video coding, a layer typically corresponds to coded pictures having video characteristics different from coded pictures in other layers. Such video characteristics typically include spatial resolution and quality level (Signal-to-Noise Ratio). In HEVC and its extensions, temporal scalability may be achieved within one layer by defining a group of pictures with a particular temporal level as a sub-layer.

For each respective layer of the bitstream, data in a lower layer may be decoded without reference to data in any higher layer. In scalable video coding, for example, data in a base layer may be decoded without reference to data in an enhancement layer. NAL units only encapsulate data of a single layer. Thus, NAL units encapsulating data of the highest remaining layer of the bitstream may be removed from the bitstream without affecting the decodability of data in the remaining layers of the bitstream. In multi-view coding and 3D-HEVC, higher layers may include additional view components. In SHEVC, higher layers may include signal to noise ratio (SNR) enhancement data, spatial enhancement data, and/or temporal enhancement data. In MV-HEVC, 3D-HEVC and SHEVC, a view may be referred to as a “base layer” if a video decoder can decode pictures in the view without reference to data of any other layer. The base layer may conform to the HEVC base specification (e.g., HEVC Working Draft 10).

In general, the techniques of this disclosure provide various improvements for tile and wavefront processing across layers in HEVC extensions and can be applied to scalable coding, multi-view coding with or without depth, and other extensions to HEVC and other multi-layer video codecs. HEVC contains several proposals to make the codec more parallel-friendly, including tiles and wavefront parallel processing (WPP).

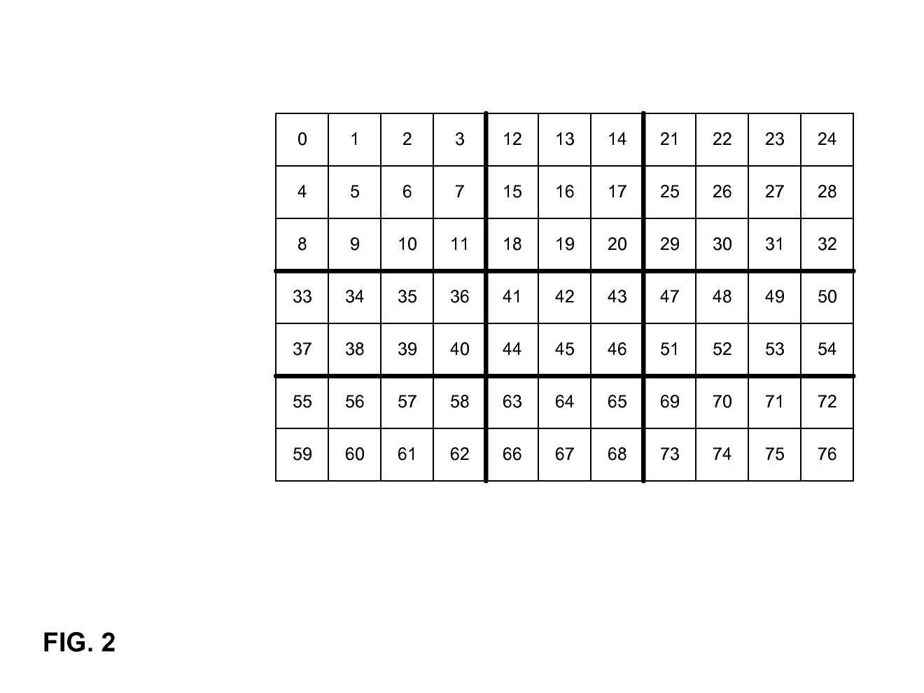

HEVC WD10 defines tiles as an integer number of coding tree blocks co-occurring in one column and one row, ordered consecutively in a coding tree block raster scan of the tile. The division of each picture into tiles is a partitioning. Tiles in a picture are ordered consecutively in the tile raster scan of the picture as shown in FIG. 2. Accordingly, FIG. 2 is a conceptual diagram illustrating an example raster scan of a picture when tiles are used.

The number of tiles and the location of their boundaries may be defined for the entire sequence or changed from picture to picture. Tile boundaries, similarly to slice boundaries, break parse and prediction dependences so that a tile can be processed independently, but the in-loop filters (de-blocking and sample adaptive offset (SAO)) can still cross tile boundaries. HEVC WD10 also specifies some constraints on the relationship between slices and tiles.

HEVC Working Draft 10 provides for a loop_filter_across_tiles_enabled_flag syntax element specified in a PPS. loop_filter_across_tiles_enabled_flag equal to 1 specifies that in-loop filtering operations may be performed across tile boundaries in pictures referring to the PPS. loop_filter_across_tiles_enabled_flag equal to 0 specifies that in-loop filtering operations are not performed across tile boundaries in pictures referring to the PPS. The in-loop filtering operations include the deblocking filter and sample adaptive offset filter operations. When not present, the value of loop_filter_across_tiles_enabled_flag is inferred to be equal to 1. An advantage of using tiles is that they do not require communication between processors or processor cores for entropy decoding and motion compensation reconstruction, but communication may be needed if loop_filter_across_tiles_enabled_flag is set to 1. Compared to slices, tiles have a better coding efficiency because tiles allow picture partition shapes that contain samples with potentially higher correlation than slices, and also because tiles reduce slice header overhead.

The tile design in HEVC WD10 may provide the following benefits: 1) enable parallel processing, and 2) improve coding efficiency by allowing a changed decoding order of CTUs compared to the use of slices, while the main benefit is the first one. When a tile is used in single-layer coding, the syntax element min_spatial_segmentation_idc may be used by a decoder to calculate the maximum number of luma samples to be processed by one processing thread, making the assumption that video decoder 30 maximally utilizes the parallel decoding information. min_spatial_segmentation_idc, when not equal to 0, establishes a bound on the maximum possible size of distinct coded spatial segmentation regions in the pictures of the CVS. When min_spatial_segmentation_idc is not present, it is inferred to be equal to 0. In HEVC WD10 there may be same picture inter-dependencies between the different threads, e.g., due to entropy coding synchronization or de-blocking filtering across tile or slice boundaries. HEVC WD10 includes a note that encourages encoders to set the value of min_spatial_segmentation_idc to be the highest possible value.

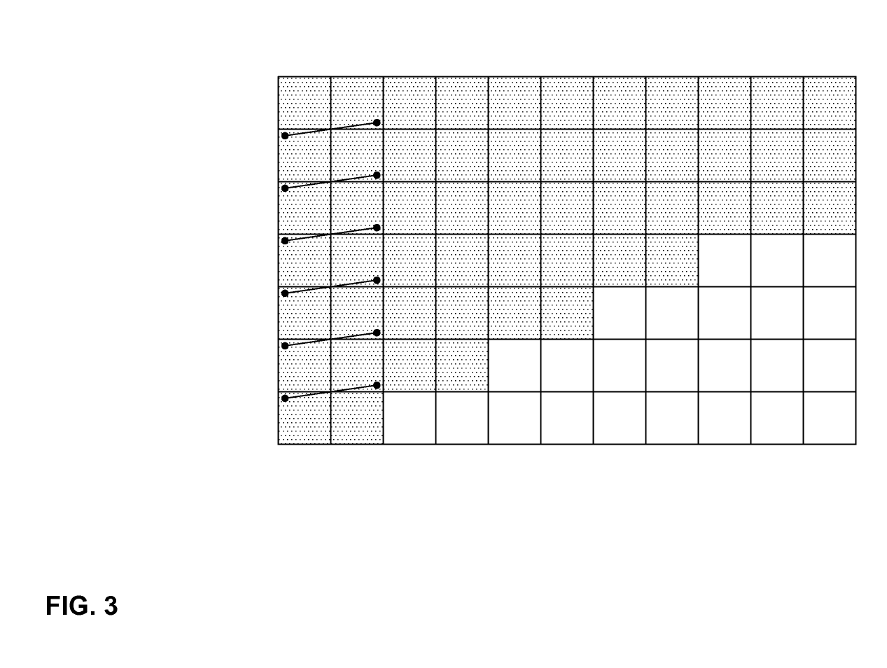

FIG. 3 is a conceptual diagram illustrating an example of wavefront parallel processing of a picture. When wavefront parallel processing (WPP) is enabled for a picture, each CTU row of the picture is a separate partition. Compared to slices and tiles, however, no coding dependences are broken at CTU row boundaries. Additionally, CABAC probabilities are propagated from the second CTU of the previous row, to further reduce the coding losses (see FIG. 3). Also, WPP does not change the regular raster scan order. Because dependences are not broken, the rate-distortion loss of a WPP bitstream is typically small compared to a nonparallel bitstream.

When WPP is enabled for a picture, a number of processors up to the number of CTU rows can work in parallel to process the CTU rows (or lines). The wavefront dependences, however, do not allow all the CTU rows to start decoding at the beginning of the picture. Consequently, the CTU rows also cannot finish decoding at the same time at the end of the picture. This introduces parallelization inefficiencies that become more evident when a high number of processors are used. In the example of FIG. 3, WPP processes rows of CTBs in parallel, each row starting with the CABAC probabilities available after processing the second CTB of the row above.

In the following sub-sections, various improvements for tile and wavefront processing across layers in HEVC extensions are proposed, which can be applied independently from each other or in combination, and which may apply to scalable coding, multi-view coding with or without depth, and other extensions to HEVC and other video codecs.

Tiles are typically used for parallel processing in HEVC and its extensions. In the multi-loop decoding framework of SHVC, it may be useful to indicate if inter-layer prediction is used for a particular tile or not. Such an indication may be used for pipelining segments/tiles of the current picture. For example, if a particular tile of an enhancement layer picture does not use inter-layer prediction, then the decoding of this tile can be scheduled in parallel to the decoding of reference layer pictures/tiles. Currently, it is not possible to know whether a particular tile in a non-base layer uses inter-layer prediction without decoding the tile. If the tile belongs to a picture of the base layer, inter-layer prediction is not used.

In one or more example techniques of this disclosure, a tile based inter-layer prediction syntax element is introduced to specify when inter-layer prediction is enabled for a particular tile in a current picture. The proposed syntax element may be signaled in any of the following parameter sets VPS, SPS, PPS, slice header, and their respective extensions. Thus, in some examples, video encoder 20 may generate one or more of the following: a VPS that includes a syntax element indicating whether inter-layer prediction is enabled for a tile, a SPS that includes the syntax element, a PPS that includes the syntax element, and/or a slice header that includes the syntax element. Similarly, in some examples, video decoder 30 may obtain the syntax element comprises obtaining the syntax element from one of: a VPS of the bitstream or an extension of the VPS, a SPS of the bitstream or an extension of the SPS, a PPS of the bitstream or an extension of the PPS, and/or a slice header of the bitstream or an extension of the slice header. The proposed syntax elements may also be signaled in one or more SEI messages.

In accordance with a first example technique of this disclosure related to tile based inter-layer prediction signaling, a video coder may use the pic_parameter_set_rbsp syntax shown in Table 1, below. The pic_parameter_set_rbsp syntax is a syntax for an RBSP of a PPS. In Table 1 below and throughout this disclosure, changes to the current standard (e.g., HEVC WD 10) that are proposed in this disclosure are indicated using italics. Elements indicated in bold are names of syntax elements.

TABLE 1
pic_parameter_set_rbsp( ) {

| | |
|---|---|
| .... | |
| .... | |
| tiles_{—}enabled_{—}flag | u(1) |
| if( tiles_enabled_flag ) { | |

| | |
|---|---|
| num_{—}tile_{—}columns_{—}minus1 | ue(v) |
| num_{—}tile_{—}rows_{—}minus1 | ue(v) |
| uniform_{—}spacing_{—}flag | u(1) |
| if( !uniform_spacing_flag ) { | |

for( i = 0; i < num_tile_columns_minus1; i++ )

| | |
|---|---|
| column_{—}width_{—}minus1[ i ] | ue(v) |

for( i = 0; i < num_tile_rows_minus1; i++ )

| | |
|---|---|
| row_{—}height_{—}minus1[ i ] | ue(v) |

for( i = 0; i < num_{—}tile_{—}columns_{—}minus1; i++ )

for( i = 0; i < num_{—}tile_{—}rows_{—}minus1; i++ )

| | |
|---|---|
| [symbol] [ j ] [ i ] | u(1) |

| | |
|---|---|
| } | |
| loop_{—}filter_{—}across_{—}tiles_{—}enabled_{—}flag | u(1) |

}
....
....

In Table 1 and other syntax tables of this disclosure, a syntax element with a descriptor of the form u(n), where n is an integer number, are unsigned integers using n bits. A syntax element with a descriptor of ue(v) is an unsigned integer 0-th order Exp-Golomb-coded syntax element with the left bit first. In at least some examples, the ue(v) syntax elements are entropy coded, and the u(n) syntax elements are not entropy coded.

In the example of Table 1, inter_layer_pred_tile_enabled_flag[j] [i] equal to 1 specifies that inter-layer prediction (sample and/or motion) may be used in decoding of the j-th the column and i-th the row. inter_layer_pred_tile_enabled_flag[j] [i] equal to 0 specifies that inter-layer prediction (sample and/or motion) is not used in decoding of the j-th the column and i-th the row. When not present, the value of inter_layer_pred_tile_enabled_flag is inferred to be equal to 0.

The syntax element inter_layer_pred_tile_enabled_flag may be signaled in either of the following parameter sets: VPS, SPS, PPS, slice header and its respective extensions. In some examples, the syntax element inter_layer_pred_tile_enabled_flag may also be signaled in an SEI message. In some examples, the syntax element inter_layer_pred_tile_enabled_flag may be signaled in SEI messages and not in parameter sets.

In accordance with a second example technique of this disclosure related to tile based inter-layer prediction signaling, a video coder may use the pic_parameter_set_rbsp syntax shown in Table 2, below. As before, changes to the current standard (e.g., HEVC WD 10) that are proposed in this disclosure are indicated using italics and names of syntax elements are shown in bold.

TABLE 2
pic_parameter_set_rbsp( ) {

| | |
|---|---|
| .... | |
| .... | |
| tiles_{—}enabled_{—}flag | u(1) |
| if( tiles_enabled_flag ) { | |

| | |
|---|---|
| num_{—}tile_{—}columns_{—}minus1 | ue(v) |
| num_{—}tile_{—}rows_{—}minus1 | ue(v) |
| uniform_{—}spacing_{—}flag | u(1) |
| if( !uniform_spacing_flag ) { | |

for( i = 0; i < num_tile_columns_minus1; i++ )

| | |
|---|---|
| column_{—}width_{—}minus1[ i ] | ue(v) |

for( i = 0; i < num_tile_rows_minus1; i++ )

| | |
|---|---|
| row_{—}height_{—}minus1[ i ] | ue(v) |

for( i = 0; i < num_{—}tile_{—}columns_{—}minus1; i++ ){

for( i = 0; i < num_{—}tile_{—}rows_{—}minus1; i++ ) {

| | |
|---|---|
| [symbol] [ j ] [ i ] | u(1) |
| [symbol] [ j ] [ i ] | u(1) |

[symbol]

}

| | |
|---|---|
| } | |
| loop_{—}filter_{—}across_{—}tiles_{—}enabled_{—}flag | u(1) |

}
....
....

In the example of Table 2, inter_layer_sample_pred_tile_enabled_flag[j] [i] equal to 1 specifies that inter-layer sample prediction may be used in decoding of the j-th the column and i-th the row. inter_layer_pred_tile_enabled_flag[j] [i] equal to 0 specifies that inter-layer sample prediction is not used in decoding of the j-th the column and i-th the row (i.e., the tile in the j-th the column and i-th column row). In some examples, when not present, the value of inter_layer_sample_pred_tile_enabled_flag is inferred to be equal to 0. In general, inter-layer sample prediction comprises predicting values of samples in blocks of a picture belonging to a current view based on values of samples in blocks of a picture belonging to a different view.

Furthermore, in the example of Table 2, inter_layer_motion_pred_tile_enabled_flag[j] [i] equal to 1 specifies that inter-layer motion prediction may be used in decoding of the j-th the column and i-th the row. inter_layer_pred_tile_enabled_flag[j] [i] equal to 0 specifies that inter-layer motion prediction is not used in decoding of the j-th the column and i-th the row. In some examples, when not present, the value of inter_layer_motion_pred_tile_enabled_flag is inferred to be equal to 0. In general, inter-layer motion prediction comprises predicting motion information (e.g., motion vectors, reference indices, etc.) of blocks (e.g., PUs) of a picture belonging to a current view based on motion information of blocks of a picture belonging to a different view.

The proposed syntax elements inter_layer_sample_pred_tile_enabled_flag and inter_layer_motion_pred_tile_enabled_flag may be signaled in either of the following parameter sets: VPS, SPS, PPS, slice header and their respective extensions. The proposed syntax elements (e.g., inter_layer_sample_pred_tile_enabled_flag, inter_layer_motion_pred_tile_enabled_flag, etc.) may also be signaled in one or more SEI messages.

In a third example technique of this disclosure related to tile based inter-layer prediction signaling, an indication of whether inter-layer prediction is used for a tile or not is signalled in an SEI message. In one example, a SEI message is signaled as shown in Table 3, below.

TABLE 3

De-
scrip-
tor

tile_interlayer_pred_info( payloadSize ) {

| | |
|---|---|
| sei_{—}pic_{—}parameter_{—}set_{—}id | ue(v) |
| for( i = 0; i <= num_tile_columns_minus1; i++ ) | |

for( j = 0; j <= num_tile_rows_minus1; j++ )

| | |
|---|---|
| inter_{—}layer_{—}pred_{—}tile_{—}enabled_{—}flag[ i ][ j ] | u(1) |

}

Table 4, below, is another example of a SEI message. In Table 4, the inter_layer_pred_tile_enabled_flag may be applicable to sets of tiles (i.e., the sets).

TABLE 4

De-
scrip-
tor

tile_interlayer_pred_info( payloadSize ) {

| | |
|---|---|
| sei_{—}pic_{—}parameter_{—}set_{—}id | ue(v) |
| for( i = 0; i <= num_tile_in_set_minus1; i++ ) | |

| | |
|---|---|
| inter_{—}layer_{—}pred_{—}tile_{—}enabled_{—}flag[ i ] | u(1) |

}

In the example of Table 4, num_tile_in_set_minus1 specifies the number of rectangular regions of tiles in a tile set and in the range of 0 to (num_tile_columns_minus1+1)*(num_tile_rows_minus1+1)−1, inclusive.

In the tile inter-layer prediction information SEI message of Tables 3 and 4, sei_pic_parameter_set_id specifies the value of pps_pic_parameter_set_id for the PPS that is referred to by the picture associated with the tile inter-layer prediction information SEI message. The value of sei_pic_parameter_set_id shall be in the range of 0 to 63, inclusive. pps_pic_parameter_set_id identifies the PPS for reference by other syntax elements. In this way, the tile inter-layer prediction information SEI message may identify pictures to which the tile inter-layer prediction information SEI message is applicable (i.e., associated).

Furthermore, in the tile inter-layer prediction information SEI message of Table 3, inter_layer_pred_tile_enabled_flag[i] [j] equal to 1 specifies that inter-layer prediction (sample and/or motion) may be used in decoding of the i-th the column and j-th the row (i.e., the tile in the i-th the column and j-th the row). inter_layer_pred_tile_enabled_flag[i] [j] equal to 0 specifies that inter-layer prediction (sample and/or motion) is not used in decoding of the i-th the column and j-th the row (i.e., the tile in the i-th the column and j-th the row). In some examples, when not present, the value of inter_layer_pred_tile_enabled_flag is inferred to be equal to 1.

In an alternative example, separate indications for motion and sample prediction are signaled in an SEI message. A SEI message in accordance with this example may be signaled as shown in Table 5 below.

TABLE 5

De-
scrip-
tor

tile_interlayer_pred_info( payloadSize ) {

| | |
|---|---|
| sei_{—}pic_{—}parameter_{—}set_{—}id | ue(v) |
| for( i = 0; i <= num_tile_columns_minus1; i++ ) | |

for( j = 0; j <= num_tile_rows_minus1; j++ ){

| | |
|---|---|
| inter_{—}layer_{—}sample_{—}pred_{—}tile_{—}enabled_{—}flag[ | u(1) |
| i ][ j ] | |
| inter_{—}layer_{—}motion_{—}pred_{—}tile_{—}enabled_{—}flag[ | u(1) |
| i ][ j ] | |

}

}

In the example of Table 5, inter_layer_sample_pred_tile_enabled_flag [i] [j] equal to 1 specifies that inter-layer sample prediction may be used in decoding of the i-th the column and j-th the row (i.e., the tile in the i-th the column and j-th the row). inter_layer_sample_pred_tile_enabled_flag[i] [j] equal to 0 specifies that inter-layer sample prediction is not used in decoding of the i-th the column and j-th the row (i.e., the tile in the i-th the column and j-th the row). In some examples, when not present, the value of inter_layer_sample_pred_tile_enabled_flag is inferred to be equal to 1.

Furthermore, in the example of Table 5, inter_layer_motion_pred_tile_enabled_flag [i] [j] equal to 1 specifies that inter-layer syntax prediction may be used in decoding of the i-th the column and j-th the row (i.e., the tile in the i-th the column and j-th the row). inter_layer_motion_pred_tile_enabled_flag[i] [j] equal to 0 specifies that inter-layer syntax prediction is not used in decoding of the i-th the column and j-th the row (i.e., the tile in the i-th the column and j-th the row). In some examples, when inter_layer_motion_pred_tile_enabled_flag is not present, the value of inter_layer_motion_pred_tile_enabled_flag is inferred to be equal to 1.

In this way, video encoder 20 may generate a bitstream that comprises a first plurality of syntax elements (e.g., inter_layer_sample_pred_tile_enabled_flag syntax elements) and a second plurality of syntax elements (e.g., inter_layer_motion_pred_tile_enabled_flag syntax elements). The first plurality of syntax elements indicates whether inter-layer sample prediction is enabled for tiles of the picture. The second plurality of syntax elements indicates whether inter-layer motion prediction is enabled for the tiles of the picture. Similarly, video decoder 30 may obtain, from the bitstream, a first plurality of syntax elements (e.g., inter_layer_sample_pred_tile_enabled_flag syntax elements) and a second plurality of syntax elements (e.g., inter_layer_motion_pred_tile_enabled_flag syntax elements). Video decoder 30 may determine, based on the first plurality of syntax elements, whether inter-layer sample prediction is enabled for each tile in the plurality of tiles (e.g., a tile set) of the picture. In addition, video decoder 30 may determine, based on the second plurality of syntax elements, whether inter-layer motion prediction is enabled for each tile in the plurality of tiles of the picture.

In a fourth example technique of this disclosure related to tile based inter-layer prediction signaling, the indication of whether inter-layer prediction is used for a particular tile is signaled in an SEI message with the syntax and semantics shown in Table 6, below.

TABLE 6

De-
scrip-
tor

tile_interlayer_pred_info( payloadSize ) {

for( i = 0; i <= num_tile_columns_minus1; i++ )

for( j = 0; j <= num_tile_rows_minus1; j++ )

| | |
|---|---|
| inter_{—}layer_{—}pred_{—}tile_{—}enabled_{—}flag[ i ][ j ] | u(1) |

}

In the example of Table 6, the tile inter-layer prediction information SEI message is a prefix SEI message and may be associated with each coded picture. HEVC Working Draft 10 defines a prefix SEI message as an SEI message contained in a prefix SEI NAL unit. Furthermore, HEVC Working Draft 10 defines a prefix SEI NAL unit as a NAL unit that has nal_unit_type equal to PREFIX SEI NUT. If a tile inter-layer prediction information SEI message is a non-nested SEI message, the associated coded picture is the coded picture containing the VCL NAL unit that is the associated VCL NAL unit of the SEI NAL unit containing the tile inter-layer prediction information SEI message. Otherwise (the SEI message is a nested SEI message), the associated coded picture is specified by the containing scalable nesting SEI message.

In the example of Table 6, inter_layer_pred_tile_enabled_flag[i][j] equal to 1 indicates that inter-layer prediction may be used in decoding the tile of the i-th the column and j-th the row. inter_layer_pred_tile_enabled_flag[i][j] equal to 0 indicates that inter-layer prediction is not used in decoding the tile of the i-th the column and j-th tile row. In some examples, when inter_layer_pred_tile_enabled_flag is not present in the tile inter-layer prediction information SEI message, the value of inter_layer_pred_tile_enabled_flag is inferred to be equal to 1.

A vui_parameters syntax structure in an SPS may include a tile_boundaries_aligned_flag syntax element. The tile_boundaries_aligned_flag equal to 1 may indicate that, when any two samples of one picture in an access unit belong to one tile, the collocated samples, if any, in another picture in the same access unit belong to one tile, and when any two samples of one picture in an access unit belong to different tiles, the collocated samples in another picture in the same access unit shall belong to different tiles. The tile_boundaries_aligned_flag equal to 0 may indicate that such a restriction may or may not apply. In other words, the tile_boundaries_aligned_flag indicates whether tile boundaries are aligned across pictures in an access unit

In accordance with some examples of this disclosure, tile parameters can be inferred (e.g., by video decoder 30) when the tile_boundaries_aligned_flag is equal to 1. In other words, a video coder, such as video decoder 30, may determine the values of particular tile parameters when a syntax element indicates that the tile boundaries of pictures are aligned in an access unit. In general, a tile parameter is a parameter that provides information about one or more tiles.

In a first example technique of this disclosure related to inferring tile parameters from a reference layer when tile_boundaries_aligned_flag=1, the tile parameters are inferred from a reference layer when tile_boundaries_aligned_flag=1, as shown in Tables 7 and 8, below.

TABLE 7
pic_parameter_set_rbsp( ) {

| | |
|---|---|
| .... | |
| .... | |
| tiles_{—}enabled_{—}flag | u(1) |
| if( tiles_enabled_flag) { | |

if ((!tile_{—}boundaries_{—}aligned_{—}flag && nuh_{—}layer_{—}id >
0) || nuh_{—}layer_{—}id ==0 ) {

| | |
|---|---|
| num_{—}tile_{—}columns_{—}minus1 | ue(v) |
| num_{—}tile_{—}rows_{—}minus1 | ue(v) |
| uniform_{—}spacing_{—}flag | u(1) |
| if( !uniform_spacing_flag ) { | |

for( i = 0; i < num_tile_columns_minus1; i++
)

| | |
|---|---|
| column_{—}width_{—}minus1[ i ] | ue(v) |

for( i = 0; i < num_tile_rows_minus1; i++ )

| | |
|---|---|
| row_{—}height_{—}minus1[ i ] | ue(v) |

}

| | |
|---|---|
| } | |
| loop_{—}filter_{—}across_{—}tiles_{—}enabled_{—}flag | u(1) |

}
....
....

TABLE 8

De-
scrip-
tor

slice_segment_header( ) {

| | |
|---|---|
| first_{—}slice_{—}segment_{—}in_{—}pic_{—}flag | u(1) |
| if( tiles_enabled_flag \| \| | |
| entropy_coding_sync_enabled_flag ) { | |

| | |
|---|---|
| if ((!tile_{—}boundaries_{—}aligned_{—}flag && nuh_{—}layer_{—}id > | |
| 0) \|\| nuh_{—}layer_{—}id ==0 ) | |
| num_{—}entry_{—}point_{—}offsets | ue(v) |
| if( num_entry_point_offsets > 0 ) { | |

| | |
|---|---|
| offset_{—}len_{—}minus1 | ue(v) |
| for( i = 0; i < num_entry_point_offsets; i++ ) | |

| | |
|---|---|
| entry_{—}point_{—}offset_{—}minus1[ i ] | u(v) |

}

}
if( slice_segment_header_extension_present_flag ) {

| | |
|---|---|
| slice_{—}segment_{—}header_{—}extension_{—}length | ue(v) |
| for( i = 0; i < slice_segment_header_extension_length; | |
| i++) | |

| | |
|---|---|
| slice_{—}segment_{—}header_{—}extension_{—}data_{—}byte[ i ] | u(8) |

}
byte_alignment( )

}

In this example, video encoder 20 may generate a bitstream that includes a first syntax element (e.g., tile_boundaries_aligned_flag), the first syntax element indicating whether tile boundaries of a picture are aligned across pictures in an access unit. Furthermore, video encoder 20 may determine, based at least in part on the first syntax element, whether to include in the bitstream a value of a second syntax element (e.g., num_tile_columns_minus1, num_tile_rows_minus1, uniform_spacing_flag, column_width_minus1, row_height_minus1, num_entry_point_offsets, offset_len_minus1, entry_point_offset_minus1), the second syntax element being a tile parameter.

Similarly, video decoder 30 may obtain, from a bitstream, a first syntax element, the first syntax element indicating whether tile boundaries of a picture are aligned across pictures in an access unit. Video decoder 30 may determine, based at least in part on the first syntax element, whether to infer a value of a second syntax element, the second syntax element being a tile parameter.

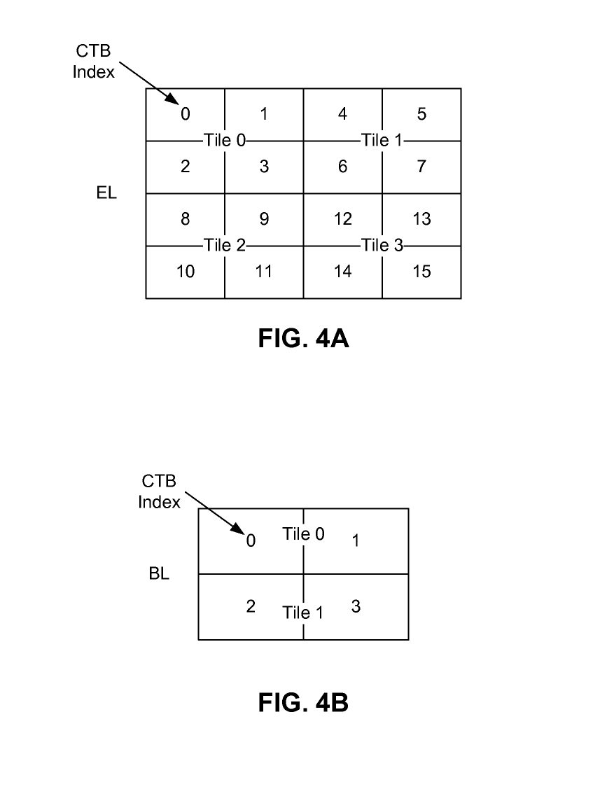

As described above, HEVC WD10 supports partitioning of a frame into one or more tiles. Each tile is associated with a tileId starting from 0 to a maximum number of tiles in a picture, minus 1, in the picture raster scan order as shown in FIGS. 4A and 4B. That is, FIG. 4A is a conceptual diagram illustrating an example raster scan order of CTUs in an enhancement layer picture having four tiles. FIG. 4B is a conceptual diagram illustrating an example raster scan order of CTUs in a base layer picture corresponding to the enhancement layer picture of FIG. 4A.

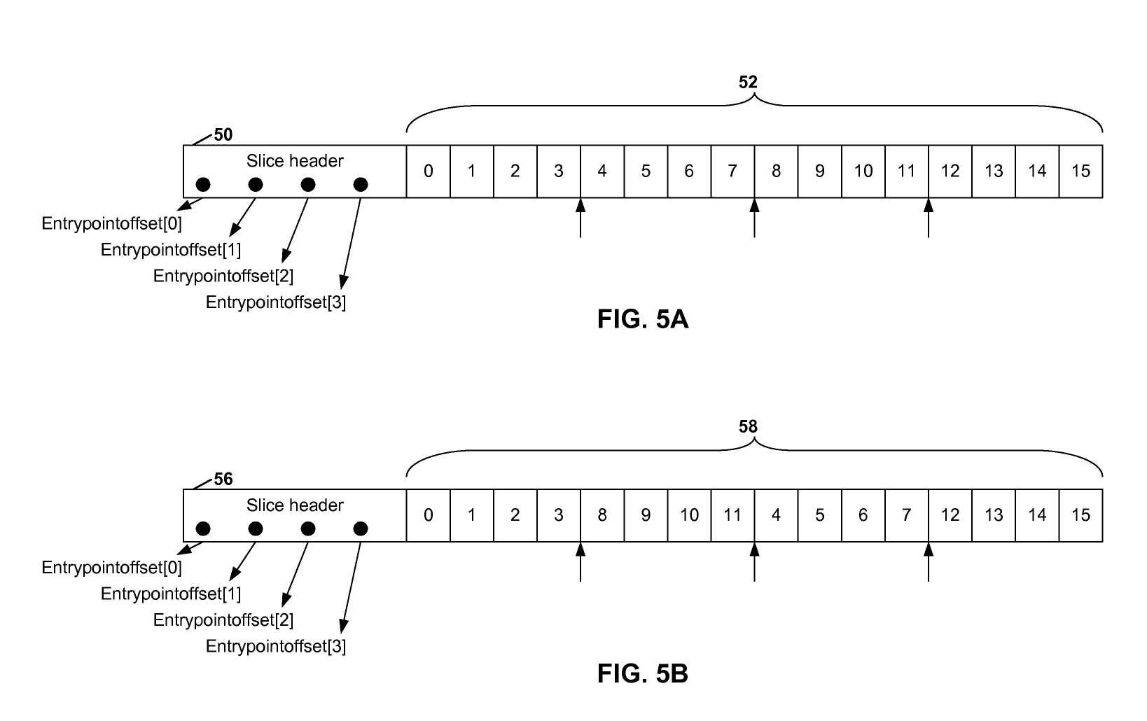

FIG. 5A is a conceptual diagram illustrating an example CTB order in a bitstream when each tile is written to the bitstream in sequential order according to tile identification in increasing order. FIG. 5B is a conceptual diagram illustrating an example CTB order in a bitstream when tiles are not written to the bitstream in sequential order according to tile identification in increasing order. In some examples, coded data from each tile is written to an output bitstream in the sequential order according to tile identification in increasing order, that is, for the above example from tile 0 to tile 3 as shown in FIG. 5A.

As shown in the example of FIG. 5A, CTUs 0-15 belong to a slice. The slice includes a slice header 50 that includes various syntax elements, including entry point offset syntax elements indicating locations of coded tiles within slice data 52 of the slice. CTUs 0-3 belong to a first tile, CTUs 4-7 belong to a second tile, CTUs 8-11 belong to a third tile, and CTUs 12-15 belong to a fourth tile. Coded representations of CTUs 0-3 are located in slice data 52 prior to coded representations of CTUs 4-7, which are located in slice data 52 prior to coded representations of CTUs 8-11, which are located in slice data 52 prior to coded representations of CTUs 12-15.

Mandating that coded data of tiles always be written in sequential order into a bitstream may not be efficient in the multi-layer context due to varying inter-layer dependencies and tile configurations. In the example tile configuration shown in FIGS. 4A and 4B, the output order illustrated in FIG. 5B may reduce delay.

In one example technique of this disclosure related to asynchronous tile output at an enhancement layer, to reduce output delay when tiles are encoded in parallel, the order of coded tiles' data in a bitstream is relaxed such that the order of the coded tiles' data in the bitstream is not necessarily always in sequential order. With this relaxed order, the coded data of tiles can be output/written asynchronously into a bitstream according to its available order during encoding. FIG. 5B shows an example of this relaxed order.

As shown in the example of FIG. 5B, CTUs 0-15 belong to a slice. The slice includes a slice header 56 that includes various syntax elements, including entry point offset syntax elements indicating locations of coded tiles within slice data 58 of the slice. CTUs 0-3 belong to a first tile, CTUs 4-7 belong to a second tile, CTUs 8-11 belong to a third tile, and CTUs 12-15 belong to a fourth tile. Coded representations of CTUs 0-3 are located in slice data 58 prior to coded representations of CTUs 8-11, which are located in slice data 58 prior to coded representations of CTUs 4-7, which are located in slice data 58 prior to coded representations of CTUs 12-15.

Table 9, below, illustrates an example syntax for a slice segment header. As shown in Table 9, a slice segment header may include tile_id_map syntax elements associated with entry point offset syntax elements. The tile_id_map syntax elements may specify identifiers of tiles associated with the entry point offset syntax elements. In this way, the slice segment header may specify the entry points of tiles of a slice and the identities of the tiles. Specifying the identities of the tiles as well as the entry points of the tiles may enable the coded data of tiles to be output/written asynchronously into a bitstream as the coded data of the tiles become available during encoding.

TABLE 9

De-
scrip-
tor

slice_segment_header( ) {

| | |
|---|---|
| first_{—}slice_{—}segment_{—}in_{—}pic_{—}flag | u(1) |
| ....... | |
| if( tiles_enabled_flag \| \| | |
| entropy_coding_sync_enabled_flag ) { | |

| | |
|---|---|
| num_{—}entry_{—}point_{—}offsets | ue(v) |
| if( num_entry_point_offsets > 0 ) { | |

| | |
|---|---|
| offset_{—}len_{—}minus1 | ue(v) |
| for( i = 0; i < num_entry_point_offsets; i++ ) { | |

| | |
|---|---|
| entry_{—}point_{—}offset_{—}minus1[ i ] | u(v) |
| if( nuh_{—}layer_{—}id > 0) | |

| | |
|---|---|
| [symbol] [ i ] | u(v) |

}

}

}
if( slice_segment_header_extension_present_flag ) {

| | |
|---|---|
| slice_{—}segment_{—}header_{—}extension_{—}length | ue(v) |
| for( i = 0; i < slice_segment_header_extension_length; | |
| i++) | |

| | |
|---|---|
| slice_{—}segment_{—}header_{—}extension_{—}data_{—}byte[ i ] | u(8) |

}
byte_alignment( )

}

In the example of Table 9, tile_id_map[i] specifies the tile identifier (i.e., tile_id) that is associated with entry_point_offset_minus1 [i]. tile_id_map[i] shall be described by log 2 ((num_tile_columns_minus1+1)*(num_tile_rows_minus1+1)). offset_tile_id [i] shall range from 0 to (num_tile_columns_minus1+1)*(num_tile_rows_minus1+1)−1, inclusively. Entry_point_offset_minus1[i] plus 1 specifies the i-th entry point offset in bytes, and is represented by offset_len_minus1 plus 1 bits. num_tile_columns_minus1 plus 1 specifies the number of tile columns partitioning the picture. num_tile_rows_minus1 plus 1 specifies the number of tile rows partitioning the picture.

In this way, video decoder 30 may obtain, from a bitstream, sets of data associated with a plurality of tiles of a picture, wherein the sets of data associated with the plurality of tiles are not ordered in the bitstream according to a sequential order of tile identifiers for the plurality of tiles. Video decoder 30 decodes the picture. Furthermore, the plurality of tiles may include a particular tile associated with a slice of the picture. Video decoder 30 may obtain, from the bitstream, a first syntax element in a slice segment header for a slice of the picture, the first syntax element indicating an entry point offset of a set of data associated with the particular tile. When the picture is not in a base layer, video decoder 30 may obtain, from the bitstream, a syntax element in the slice segment header for a slice of the picture, the syntax element indicating an identifier of a tile associated with the slice.

Similarly, video encoder 20 may generate a bitstream that includes sets of data associated with a plurality of tiles of a picture, wherein the sets of data associated with the plurality of tiles are not ordered in the bitstream according to a sequential order of tile identifiers for the plurality of tiles. The plurality of tiles may include a particular tile associated with a slice of the picture. Video encoder 20 may include, in the bitstream, a first syntax element in a slice segment header for a slice of the picture, the first syntax element indicating an entry point offset of a set of data associated with the particular tile. When the picture is not in a base layer, video encoder 20 may include, in the bitstream, a syntax element in the slice segment header for a slice of the picture, the syntax element indicating an identifier of a tile associated with the slice.

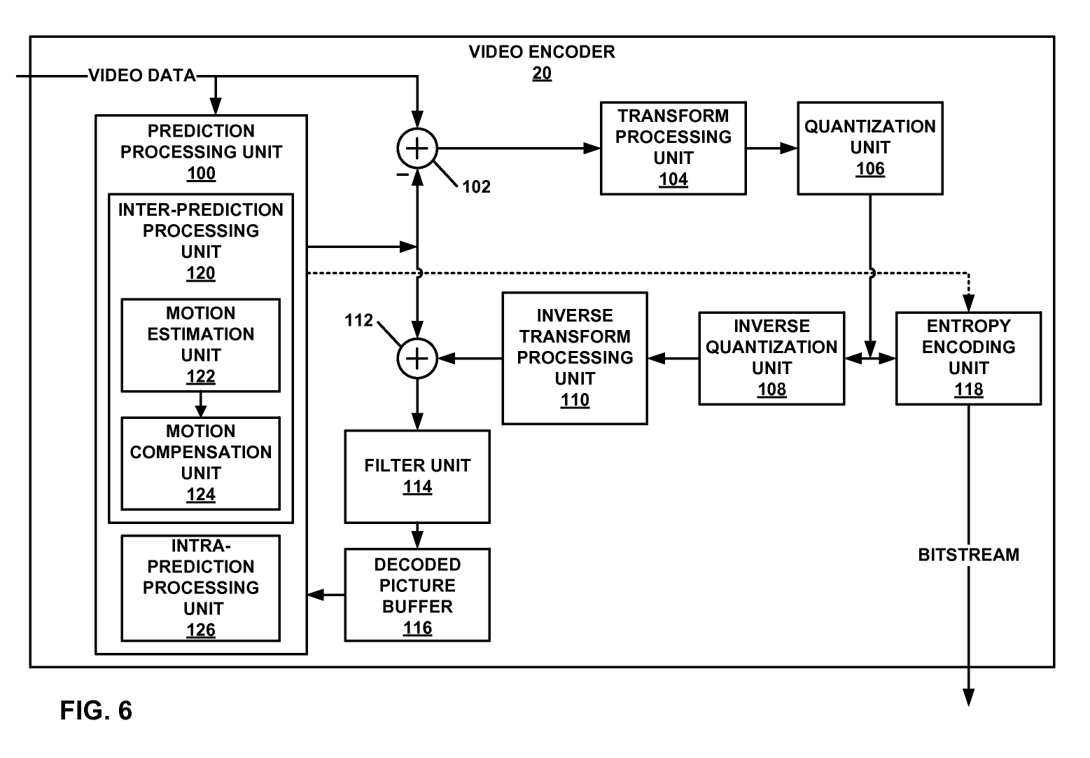

FIG. 6 is a block diagram illustrating an example video encoder 20 that may implement the techniques of this disclosure. FIG. 6 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

In the example of FIG. 6, video encoder 20 includes a prediction processing unit 100, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 includes a motion estimation unit 122 and a motion compensation unit 124. In other examples, video encoder 20 may include more, fewer, or different functional components.

Video encoder 20 may receive video data. Video encoder 20 may encode each CTU in a slice of a picture of the video data. Each of the CTUs may be associated with equally-sized luma coding tree blocks (CTBs) and corresponding chroma CTBs of the picture. As part of encoding a CTU, prediction processing unit 100 may perform quad-tree partitioning to divide the CTBs of the CTU into progressively-smaller blocks. The smaller blocks may be coding blocks of CUs. For example, prediction processing unit 100 may partition a CTB corresponding to (i.e., associated with) a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, prediction processing unit 100 may partition the coding blocks of (i.e., associated with) the CU among one or more PUs of the CU. Thus, each PU may have (i.e., be associated with) a luma prediction block and corresponding chroma prediction blocks. Video encoder 20 and video decoder 30 may support PUs having various sizes. The size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 120 may generate predictive data for a PU by performing inter prediction on each PU of a CU. The predictive data for the PU may include predictive blocks of the PU and motion information for the PU. Inter-prediction processing unit 120 may perform different operations for a PU of a CU depending on whether the PU is in an I slice, a P slice, or a B slice. In an I slice, all PUs are intra predicted. Hence, if the PU is in an I slice, inter-prediction processing unit 120 does not perform inter prediction on the PU.

PUs in a P slice may be intra predicted or uni-directionally inter predicted. For instance, if a PU is in a P slice, motion estimation unit 122 may search the reference pictures in RefPicList0 for a reference region for the PU. The reference region for the PU may be a region, within a reference picture, that contains sample blocks that most closely correspond to the prediction blocks of the PU. Motion estimation unit 122 may generate a reference index that indicates a position in RefPicList0 of the reference picture containing the reference region for the PU. In addition, motion estimation unit 122 may generate a motion vector that indicates a spatial displacement between a prediction block of the PU and a reference location associated with the reference region. For instance, the motion vector may be a two-dimensional vector that provides an offset from the coordinates in the current decoded picture to coordinates in a reference picture. Motion estimation unit 122 may output the reference index and the motion vector as the motion information of the PU. Motion compensation unit 124 may generate the predictive blocks of the PU based on actual or interpolated samples at the reference location indicated by the motion vector of the PU.

PUs in a B slice may be intra predicted, uni-directionally inter predicted, or bi-directionally inter predicted. Hence, if a PU is in a B slice, motion estimation unit 122 may perform uni-prediction or bi-prediction for the PU. To perform uni-prediction for the PU, motion estimation unit 122 may search the reference pictures of RefPicList0 or RefPicList1 for a reference region for the PU. Motion estimation unit 122 may output, as the motion information of the PU, a reference index that indicates a position in RefPicList0 or RefPicList1 of the reference picture that contains the reference region, a motion vector that indicates a spatial displacement between a predictive block of the PU and a reference location associated with the reference region, and one or more prediction direction indicators that indicate whether the reference picture is in RefPicList0 or RefPicList1. Motion compensation unit 124 may generate the predictive blocks of the PU based at least in part on actual or interpolated samples at the reference location indicated by the motion vector of the PU.

To perform bi-directional inter prediction for a PU, motion estimation unit 122 may search the reference pictures in RefPicList0 for a reference region for the PU and may also search the reference pictures in RefPicList1 for another reference region for the PU. Motion estimation unit 122 may generate reference indexes that indicate positions in RefPicList0 and RefPicList1 of the reference pictures that contain the reference regions. In addition, motion estimation unit 122 may generate motion vectors that indicate spatial displacements between the reference locations associated with the reference regions and a sample block of the PU. The motion information of the PU may include the reference indexes and the motion vectors of the PU. Motion compensation unit 124 may generate the predictive blocks of the PU based at least in part on actual or interpolated samples at the reference locations indicated by the motion vectors of the PU.

Intra-prediction processing unit 126 may generate predictive data for a PU by performing intra prediction on the PU. The predictive data for the PU may include predictive blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. Intra-prediction processing unit 126 may generate a predictive block of a PU based on samples from sample blocks of spatially-neighboring PUs. The spatially-neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes, e.g., 33 directional intra prediction modes. In some examples, the number of intra prediction modes may depend on the size of the prediction blocks of the PU.

Prediction processing unit 100 may select the predictive data for PUs of a CU from among the predictive data generated by inter-prediction processing unit 120 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive blocks of the selected predictive data may be referred to herein as the selected predictive blocks.

Residual generation unit 102 may generate, based on the coding blocks (e.g., luma, Cb, and Cr coding blocks) of a CU and the selected predictive blocks (e.g., predictive luma, Cb, and Cr blocks) of the PUs of the CU, residua blocks (e.g., luma, Cb, and Cr residual blocks) of the CU. For instance, residual generation unit 102 may generate the residual blocks of the CU such that each sample in the residual blocks has a value equal to a difference between a sample in a coding block of the CU and a corresponding sample in a corresponding selected predictive block of a PU of the CU.

Transform processing unit 104 may perform quad-tree partitioning to partition the residual blocks associated with a CU into transform blocks associated with TUs of the CU. Thus, a TU may correspond to (i.e., be associated with) a luma transform block and two chroma transform blocks. The sizes and positions of the luma and chroma transform blocks of TUs of a CU may or may not be based on the sizes and positions of prediction blocks of the PUs of the CU.

Transform processing unit 104 may generate coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually-similar transform to a transform block. In some examples, transform processing unit 104 does not apply transforms to a transform block. In such examples, the transform block may be treated as a coefficient block.

Quantization unit 106 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU. Quantization may introduce loss of information, thus quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive blocks generated by prediction processing unit 100 to produce a reconstructed transform block associated with a TU. By reconstructing transform blocks for each TU of a CU in this way, video encoder 20 may reconstruct the coding blocks of the CU.

Filter unit 114 may perform one or more deblocking operations to reduce blocking artifacts in the coding blocks associated with a CU. Decoded picture buffer 116 may store the reconstructed coding blocks after filter unit 114 performs the one or more deblocking operations on the reconstructed coding blocks. Inter-prediction processing unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a CABAC operation, a context-adaptive variable length coding (CAVLC) operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. The bitstream may also include syntax elements that are not entropy encoded.

In accordance with one or more examples of this disclosure, video encoder 20 may signal, in the bitstream, syntax elements that indicate whether inter-layer prediction is enabled for particular tiles of pictures. Furthermore, in some examples, video encoder 20 may generate separate syntax elements to indicate whether inter-layer sample prediction and inter-layer motion prediction is enabled for a particular tile of a picture.

In some examples, video encoder 20 may generate a bitstream that includes a tile_boundaries_aligned_flag syntax element that indicates whether tile boundaries of a picture are aligned across pictures in an access unit. Furthermore, video encoder 20 may determine, based at least in part on the first syntax element, whether to include in the bitstream a value of a tile parameter syntax element. In some examples, the tile parameter syntax element is in a picture parameter set and indicates one of a number of tile columns, a number of tile rows, whether tiles are uniformly spaced, a column width of tiles, or a row height of tiles. In other examples, the tile parameter syntax element is in a slice segment header and indicates a number of entry point offsets for tiles.

In addition, in some examples, video encoder 20 may generate a bitstream that includes sets of data associated with a plurality of tiles of a picture, wherein the sets of data associated with the plurality of tiles are not ordered in the bitstream according to a sequential order of tile identifiers for the plurality of tiles.

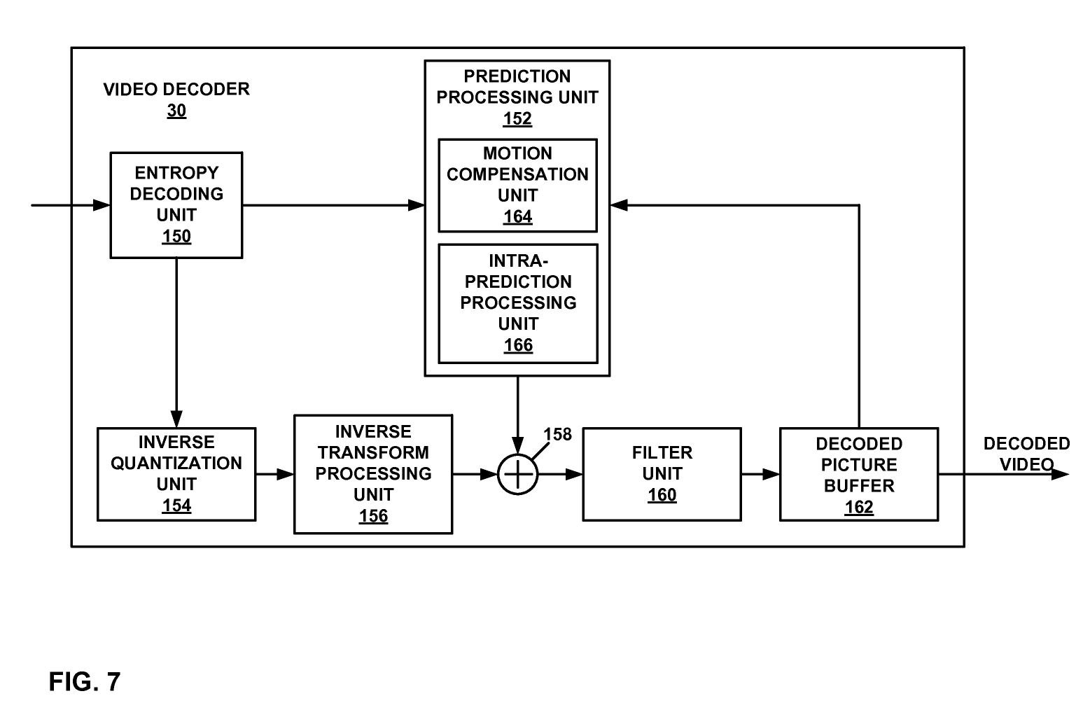

FIG. 7 is a block diagram illustrating an example video decoder 30 that may implement the techniques described in this disclosure. FIG. 7 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 7, video decoder 30 includes an entropy decoding unit 150, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. In other examples, video decoder 30 may include more, fewer, or different functional components.

Entropy decoding unit 150 may receive NAL units of a bitstream and may parse the NAL units to obtain syntax elements from the bitstream. Entropy decoding unit 150 may entropy decode entropy-encoded syntax elements in the NAL units. Prediction processing unit 152, inverse quantization unit 154, inverse transform processing unit 156, reconstruction unit 158, and filter unit 160 may generate decoded video data based on the syntax elements obtained from the bitstream.

The NAL units of the bitstream may include coded slice NAL units. As part of decoding the bitstream, entropy decoding unit 150 may entropy decode syntax elements from the coded slice NAL units. Each of the coded slices may include a slice header and slice data. The slice header may contain syntax elements pertaining to a slice. The syntax elements in the slice header may include a syntax element that identifies a PPS associated with a picture that contains the slice.

In addition to decoding syntax elements from the bitstream, video decoder 30 may perform reconstruction operations on CUs. To perform the reconstruction operation on a CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, inverse quantization unit 154 may inverse quantize, i.e., de-quantize, coefficient blocks associated with the TU. Inverse quantization may increase the amount of data used to represent the transform coefficients. Inverse quantization unit 154 may use a QP value associated with the CU of the TU to determine a degree of quantization and, likewise, a degree of inverse quantization for inverse quantization unit 154 to apply.

After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, intra-prediction processing unit 166 may perform intra prediction to generate predictive blocks for the PU. Intra-prediction processing unit 166 may use an intra prediction mode to generate the predictive blocks (e.g., predictive luma, Cb, and Cr blocks) for the PU based on the prediction blocks of spatially-neighboring PUs. Intra-prediction processing unit 166 may determine the intra prediction mode for the PU based on one or more syntax elements decoded from the bitstream.

Prediction processing unit 152 may construct a first reference picture list (RefPicList0) and a second reference picture list (RefPicList1) based on syntax elements extracted from the bitstream. Furthermore, if a PU is encoded using inter prediction, entropy decoding unit 150 may determine motion information for the PU. Motion compensation unit 164 may determine, based on the motion information of the PU, one or more reference regions for the PU. Motion compensation unit 164 may generate, based on samples at the one or more reference regions for the PU, predictive blocks (e.g., predictive luma, Cb, and Cr blocks) for the PU.

Reconstruction unit 158 may use the transform blocks (e.g., luma, Cb, and Cr transform blocks) of (i.e., associated with) TUs of a CU and the predictive blocks (e.g., predictive luma, Cb, and Cr blocks) of the PUs of the CU, i.e., either intra-prediction data or inter-prediction data, as applicable, to reconstruct the coding blocks (e.g., luma, Cb, and Cr coding blocks) of the CU. For example, reconstruction unit 158 may add samples of the transform blocks (e.g., luma, Cb, and Cr transform blocks) to corresponding samples of the predictive blocks (e.g., predictive luma, Cb, and Cr blocks) to reconstruct the coding blocks (e.g., luma, Cb, and Cr coding blocks) of the CU.

Filter unit 160 may perform a deblocking operation to reduce blocking artifacts associated with the coding blocks (e.g., luma, Cb, and Cr coding blocks) of the CU. Video decoder 30 may store the coding blocks (e.g., luma, Cb, and Cr coding blocks) of the CU in decoded picture buffer 162. Decoded picture buffer 162 may provide reference pictures for subsequent motion compensation, intra prediction, and presentation on a display device, such as display device 32 of FIG. 1. For instance, video decoder 30 may perform, based on the blocks (e.g., luma, Cb, and Cr blocks) in decoded picture buffer 162, intra prediction or inter prediction operations on PUs of other CUs.

In some examples of this disclosure, video decoder 30 may obtain, from the bitstream, a syntax element that indicates whether inter-layer prediction is enabled for decoding a tile of a picture. Thus, video decoder 30 may determine, based on the syntax element, whether inter-layer prediction is enabled for decoding a tile of a picture of the video data. Video decoder 30 may then decode the tile to reconstruct pixel sample values associated with the tile. In some examples, video decoder 30 may obtain, from the bitstream, a syntax element that indicate whether inter-layer sample prediction is enabled for a tile and another syntax element that indicates whether inter-layer motion prediction is enabled for the same tile.

Furthermore, in some examples of this disclosure, video decoder 30 may obtain, from a bitstream, a tile_boundaries_aligned_flag syntax element that indicates whether tile boundaries of a picture are aligned across pictures in an access unit. In addition, video decoder 30 may determine, based at least in part on the tile_boundaries_aligned_flag syntax element, whether to infer a value of a tile parameter syntax element. For example, video decoder 30 may determine, based at least in part on the tile_boundaries_aligned_flag syntax element, whether to infer a value of a tile parameter syntax element without obtaining the tile parameter syntax element from the bitstream. In some examples, the tile parameter syntax element is in a picture parameter set and indicates one of a number of tile columns, a number of tile rows, whether tiles are uniformly spaced, a column width of tiles, or a row height of tiles. In other examples, the tile parameter syntax element is in a slice segment header and indicates a number of entry point offsets for tiles.

In some examples of this disclosure, video decoder 30 may obtain, from a bitstream, sets of data associated with a plurality of tiles of a picture. In such examples, the sets of data associated with the plurality of tiles may or may not be ordered in the bitstream according to a sequential order of tile identifiers for the plurality of tiles.

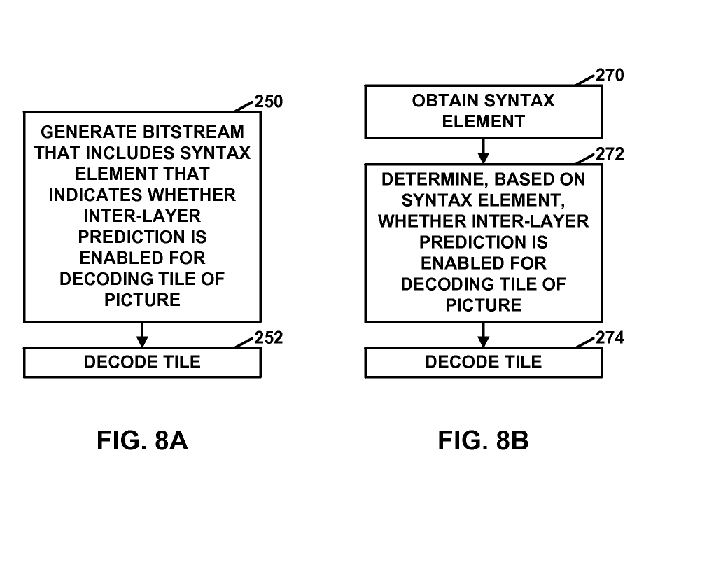

FIG. 8A is a flowchart illustrating an example operation of video encoder 20, in accordance with one or more techniques of this disclosure. FIG. 8A and the other flowcharts of this disclosure are provided as examples. Other example operations of video coders in accordance with the techniques of this disclosure may include more, fewer, or different actions.

In the example of FIG. 8A, video encoder 20 generates a bitstream that includes a syntax element (e.g., inter_layer_pred_tile_enabled_flag) that indicates whether inter-layer prediction is enabled for decoding a tile of a picture of the video data (250). The picture may be partitioned into a plurality of tiles. Furthermore, in some instances, the picture is not in a base layer (e.g., a base view). Rather, the picture may be in an enhancement layer or different view. In some examples, the inter-layer prediction comprises inter-layer sample prediction. Furthermore, in some examples, the inter-layer prediction comprises inter-layer motion prediction. In some examples, video encoder 20 may generate a bitstream such that the bitstream includes a plurality of syntax elements (e.g., inter_layer_pred_tile_enabled_flag syntax elements, inter_layer_sample_pred_tile_enabled_flag syntax elements, inter_layer_motion_pred_tile_enabled_flag syntax elements) that indicate whether inter-layer prediction is enabled for each tile of the picture.

In some examples, video encoder 20 may generate one or more of the following: a VPS that includes the syntax element, a SPS that includes the syntax element, a PPS that includes the syntax element, and/or a slice header that includes the syntax element. In some examples, video encoder 20 may generate an SEI message that includes the syntax element. In some examples, the SEI message includes a syntax element (e.g., sei_pic_parameter_set_id) that specifies a value of a PPS identifier for a PPS referred to by the picture. Furthermore, in some examples, the SEI message is a prefix SEI message that is associated with the picture.

In addition, video encoder 20 may output the bitstream (252). In some examples, outputting the bitstream comprises outputting the bitstream to one or more media or devices. Such media or devices may be capable of moving encoded video data to a destination device (e.g., destination device 14). In some examples, the one or more media may include computer-readable data storage media or communication media.

FIG. 8B is a flowchart illustrating an example operation of video decoder 30, in accordance with one or more techniques of this disclosure. In the example of FIG. 8B, video decoder 30 obtains, from a bitstream, a syntax element (e.g., inter_layer_pred_tile_enabled_flag) (270). The syntax element obtained in the bitstream may specify whether inter-layer prediction is enabled for a tile. In some examples, the inter-layer prediction comprises inter-layer sample prediction. Furthermore, in some examples, the inter-layer prediction comprises inter-layer motion prediction. In some examples, video decoder 30 may obtain, from the bitstream, a plurality of syntax elements (e.g., inter_layer_pred_tile_enabled_flag syntax elements, inter_layer_sample_pred_tile_enabled_flag syntax elements, inter_layer_motion_pred_tile_enabled_flag syntax elements) and may determine, based on the plurality of syntax elements, whether inter-layer prediction is enabled for each tile in the plurality of tiles of the picture.

To obtain the syntax element from the bitstream, video decoder 30 may parse the bitstream to determine the value of the syntax element. In some examples, parsing the bitstream to determine the value of the syntax element may involve entropy decoding data of the bitstream. In some examples, video decoder 30 may obtain the syntax element from one of: a VPS of the bitstream or an extension of the VPS, a SPS of the bitstream or an extension of the SPS, a PPS of the bitstream or an extension of the PPS, or a slice header of the bitstream or an extension of the slice header.

In some examples, video decoder 30 obtains the syntax element from an SEI message of the bitstream. Furthermore, in some such examples, video decoder 30 may obtain, from the SEI message, a syntax element (e.g., sei_pic_parameter_set_id) specifying a value of a picture parameter set identifier for a picture parameter set referred to by the picture. Furthermore, in some examples, the SEI message is a prefix SEI message that is associated with the picture.

In the example of FIG. 8B, video decoder 30 may determine, based on the syntax element, whether inter-layer prediction is enabled for decoding a tile of a picture of the video data (272). The picture may be partitioned into a plurality of tiles. Furthermore, in some instances, the picture is not in a base layer. Video decoder 30 may decode the tile (274). In general, decoding the tile may involve reconstructing sample values of blocks (e.g., CTUs, CUs, etc.) of the tile. In some examples, video decoder 30 may determine how to decode the tile based on whether inter-layer prediction is enabled for decoding the tile. For instance, when the tile does not use inter-layer prediction, video decoder 30 may decode the tile in parallel with a reference layer picture or tile. For instance, different processing cores and/or threads may decode the tile in parallel with a portion of a reference layer picture (e.g., a tile of the reference layer picture). When video decoder 30 decodes the tile using inter layer prediction, video decoder 30 may not be able to decode the tile in parallel with inter-view reference pictures (or portions thereof). As indicated elsewhere in this disclosure, when video decoder 30 decodes the tile, video decoder 30 may determine values of pixels of the tile.

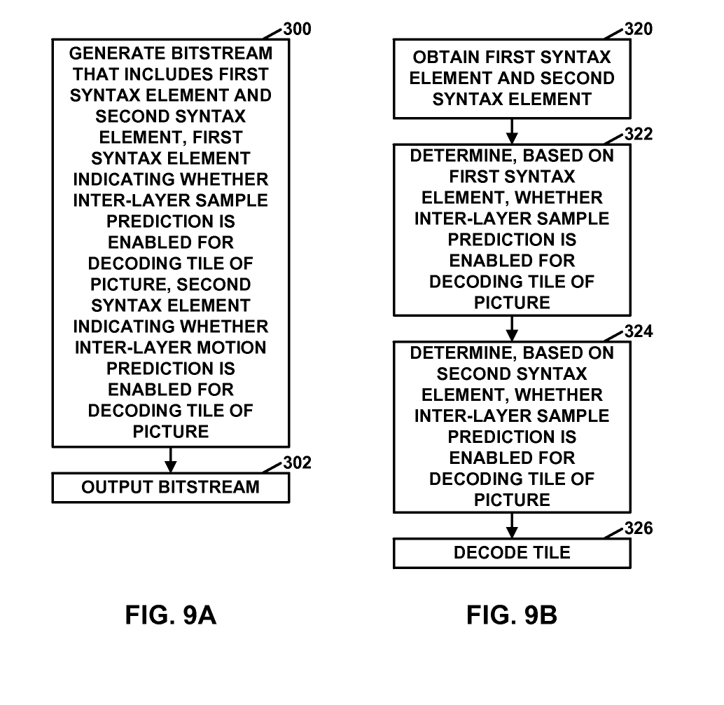

FIG. 9A is a flowchart illustrating an example operation of video encoder 20, in accordance with one or more techniques of this disclosure. In the example of FIG. 9A, video encoder 20 generates a bitstream that includes a first syntax element (e.g., inter_layer_sample_pred_tile_enabled_flag) and a second syntax element (e.g., inter_layer_motion_pred_tile_enabled_flag) (300). The first syntax element indicates whether inter-layer sample prediction is enabled for decoding a tile of a picture of the video data. The second syntax element indicates whether inter-layer motion prediction is enabled for decoding the tile. Furthermore, in the example of FIG. 9A, video encoder 20 may output the bitstream (302).

In some examples, when video encoder 20 generates the bitstream, video encoder 20 may generate a VPS that includes the first and second syntax elements. Furthermore, in some examples, when video encoder 20 generates the bitstream, video encoder 20 may generate a SPS that includes the first and second syntax elements. Additionally, in some examples, when video encoder 20 generates the bitstream, video encoder 20 may generate a PPS that includes the first and second syntax elements. In some examples, when video encoder 20 generates the bitstream, video encoder 20 may generate a slice header that includes the first and second syntax elements.

In some examples, when video encoder 20 generates the bitstream, video encoder 20 may generate a SEI message that includes the first and second syntax elements. In some such examples, the SEI message comprises a third syntax element (e.g., sei_pic_parameter_set_id) specifying an identifier of a parameter set. The parameter set may be a PPS or another type of parameter set.

FIG. 9B is a flowchart illustrating an example operation of video decoder 30, in accordance with one or more techniques of this disclosure. In the example of FIG. 9B, video decoder 30 obtains, from a bitstream, a first syntax element (e.g., inter_layer_sample_pred_tile_enabled_flag) and a second syntax element (e.g., inter_layer_motion_pred_tile_enabled_flag) (320). Video decoder 30 may determine, based on the first syntax element, whether inter-layer sample prediction is enabled for decoding a tile of a picture of the video data (322). Additionally, video decoder 30 may determine, based on the second syntax element, whether inter-layer motion prediction is enabled for decoding the tile (324). Video decoder 30 may then decode the tile (326). In some examples, when video decoder 30 determines that inter-layer sample prediction and inter-layer motion prediction are not enabled for the tile, video decoder 30 may decode the tile in parallel with one or more inter-view reference pictures (e.g., pictures belonging to the same access unit and different views than the current picture) or tiles thereof. When video decoder 30 determines that inter-layer sample prediction and/or inter-layer motion prediction are enabled for the tile, video decoder 30 may not be able to decode the tile in parallel with other inter-view reference pictures (e.g., pictures belonging to the same access unit and different views than the current picture) or tiles thereof.

In some examples, video decoder 30 obtains the first and second syntax elements from a VPS of the bitstream or an extension of the VPS. In some examples, video decoder 30 obtains the first and second syntax elements from a SPS of the bitstream or an extension of the SPS. Furthermore, in some examples, video decoder 30 obtains the syntax element from a PPS of the bitstream or an extension of the PPS. Additionally, in some examples, video decoder 30 obtains the first and second syntax elements from a slice header of the bitstream or an extension of the slice header.

In some examples, video decoder 30 obtains the first and second syntax elements from a SEI message of the bitstream. In some such examples, the SEI message comprises a third syntax element that specifies an identifier of a parameter set. The parameter set may be a PPS or another type of parameter set.

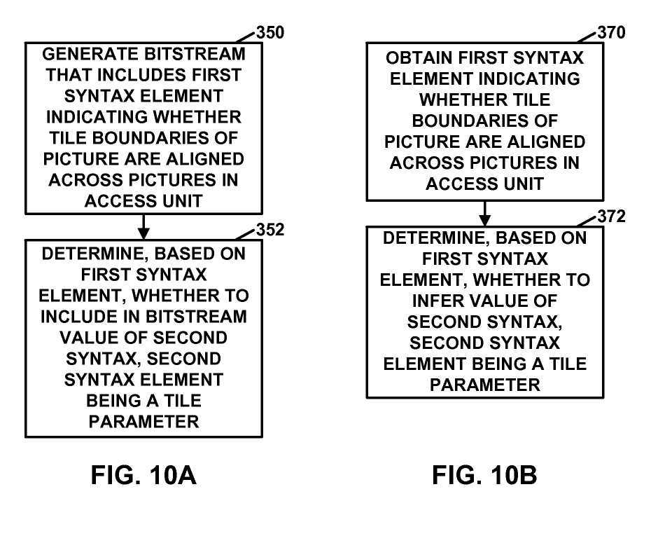

FIG. 10A is a flowchart illustrating an example operation of video encoder 20, in accordance with one or more techniques of this disclosure. In the example of FIG. 10A, video encoder 20 generates a bitstream that includes a first syntax element (e.g., tile_boundaries_aligned_flag) that indicates whether tile boundaries of a picture are aligned across pictures in an access unit (350). Video encoder 20 may determine, based at least in part on the first syntax element, whether to include in the bitstream a value of a second syntax element, the second syntax element being a tile parameter (352). In other words, depending on the value of the first syntax element, video encoder 20 may be relied upon to include or exclude the second syntax element. For instance, when the first syntax element indicates that the tile boundaries of a picture are not aligned across pictures in an access unit, video encoder 20 may include the second syntax element. When the first syntax element indicates that the tile boundaries of a picture are aligned across pictures in the access unit, video encoder 20 may not include the second syntax element. In some examples, the second syntax element may be a syntax element of a picture parameter set and the second syntax element indicates one of: a number of tile columns, a number of tile rows, whether tiles are uniformly spaced, a column width of tiles, or a row height of tiles. In some examples, the second syntax element is a syntax element of a slice segment header and the second syntax element indicates a number of entry point offsets for tiles.

FIG. 10B is a flowchart illustrating an example operation of video decoder 30, in accordance with one or more techniques of this disclosure. In the example of FIG. 10B, video decoder 30 obtains, from a bitstream, a first syntax element (e.g., tile_boundaries_aligned_flag) that indicates whether tile boundaries of a picture are aligned across pictures in an access unit (370). Video decoder 30 may determine, based at least in part on the first syntax element, whether to infer a value of a second syntax element, the second syntax element being a tile parameter (372). In some examples, the second syntax element is a syntax element of a picture parameter set and the second syntax element indicates one of: a number of tile columns, a number of tile rows, whether tiles are uniformly spaced, a column width of tiles, or a row height of tiles. In some examples, the second syntax element is a syntax element of a slice segment header and the second syntax element indicates a number of entry point offsets for tiles.

As indicated above, video decoder 30 may infer the value of the second syntax element. For instance, the second syntax element may be the num_tile_columns_minus1 syntax element and video decoder 30 may infer that the value of the num_tile_columns_minus1 syntax element is equal to 0. In another example, the second syntax element may be the num_tile_rows_minus1 syntax element and video decoder 30 may infer that the value of the num_tile_rows_minus1 syntax element is equal to 0. In another example, the second syntax element may be the uniform_spacing_flag syntax element and video decoder 30 may infer that the value of the uniform_spacing_flag syntax element is equal to 1. In another example, the second syntax element may be the num_entry_point_offsets syntax element and video decoder 30 may infer that the value of the num_entry_point_offsets syntax element is equal to 0.

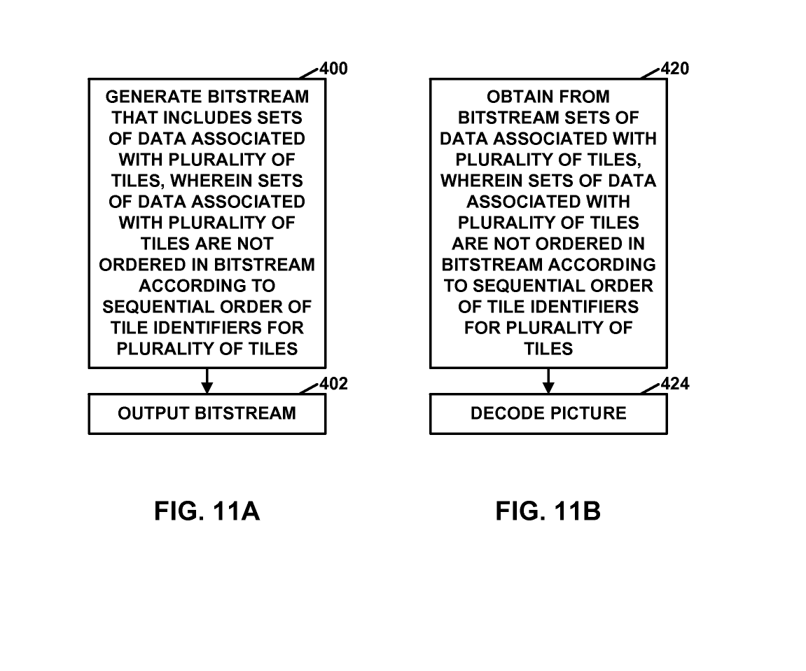

FIG. 11A is a flowchart illustrating an example operation of video encoder 20, in accordance with one or more techniques of this disclosure. In the example of FIG. 11A, video encoder 20 generates a bitstream that includes sets of data associated with a plurality of tiles of a picture (400). The sets of data associated with the plurality of tiles are not ordered in the bitstream according to a sequential order of tile identifiers (e.g., tileId's) for the plurality of tiles. Instead, the set of data may be ordered according to an order in which the encoded tiles become available as video encoder 20 encodes the tiles. Video encoder 20 may output the bitstream (402). In some examples, the plurality of tiles includes a particular tile associated with a slice of the picture. In such examples, video encoder 20 may include, in the bitstream, a first syntax element in a slice segment header for a slice of the picture (e.g., first_slice_segment_in_pic_flag). The first syntax element indicates an entry point offset of a set of data associated with the particular tile. Furthermore, in such examples, when the picture is not in a base layer, video encoder 20 may include, in the bitstream, a syntax element (e.g., tile_id_map) in the slice segment header for a slice of the picture. This syntax element (e.g., tile_id_map) indicates an identifier of a tile associated with the slice.

FIG. 11B is a flowchart illustrating an example operation of video decoder 30, in accordance with one or more techniques of this disclosure. In the example of FIG. 11B, video decoder 30 may obtain, from a bitstream, sets of data associated with a plurality of tiles of a picture (420). The sets of data associated with the plurality of tiles are not ordered in the bitstream according to a sequential order of tile identifiers for the plurality of tiles. Video decoder 30 decodes the picture (424).

In some examples, the plurality of tiles includes a particular tile associated with a slice of the picture. Furthermore, in such examples, video decoder 30 may obtain, from the bitstream, a first syntax element in a slice segment header for a slice of the picture (e.g., first_slice_segment_in_pic_flag). The first syntax element indicates an entry point offset of a set of data associated with the particular tile. When the picture is not in a base layer, video decoder 30 may obtain, from the bitstream, a syntax element (e.g., tile_id_map) in the slice segment header for a slice of the picture, the syntax element indicating an identifier of a tile associated with the slice.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples, or combinations thereof, are within the scope of the following claims.

What is claimed is:

1. A method of decoding video data, the method comprising:
obtaining, from a bitstream, a syntax element;
determining, based on the syntax element, whether inter-layer prediction is enabled for decoding a tile of a picture of the video data, wherein the picture is partitioned into a plurality of tiles and the picture is not in a base layer; and
decoding the tile.

2. The method of claim 1, wherein the syntax element specifies whether inter-layer prediction is enabled for the tile.

3. The method of claim 1, wherein obtaining the syntax element comprises obtaining the syntax element from a Supplemental Enhancement Information (SEI) message of the bitstream.

4. The method of claim 3, wherein:
the syntax element is a first syntax element, and
the method further comprises obtaining, from the SEI message, a second syntax element, the second syntax element specifying a value of a picture parameter set identifier for a picture parameter set referred to by the picture.

5. The method of claim 3, wherein the SEI message is a prefix SEI message that is associated with the picture.

6. The method of claim 1, wherein:
the syntax element is a first syntax element, and
the method further comprises:
obtaining, from the bitstream, a plurality of syntax elements that includes the first syntax element; and
determining, based on the plurality of syntax elements, whether inter-layer prediction is enabled for each tile in the plurality of tiles of the picture.

7. The method of claim 1, wherein inter-layer prediction comprises inter-layer sample prediction.

8. The method of claim 1, wherein inter-layer prediction comprises inter-layer motion prediction.

9. The method of claim 1, wherein obtaining the syntax element comprises obtaining the syntax element from one of: a video parameter set (VPS) of the bitstream or an extension of the VPS, a sequence parameter set (SPS) of the bitstream or an extension of the SPS, a picture parameter set (PPS) of the bitstream or an extension of the PPS, or a slice header of the bitstream or an extension of the slice header.

10. The method of claim 1, wherein decoding the tile comprises, when the tile does not use inter-layer prediction, decoding the tile in parallel with a reference layer picture or tile.

11. A method for encoding video data, the method comprising:
generating a bitstream that includes a syntax element that indicates whether inter-layer prediction is enabled for decoding a tile of a picture of the video data, wherein the picture is partitioned into a plurality of tiles and the picture is not in a base layer; and
outputting the bitstream.

12. The method of claim 11, wherein generating the bitstream comprises generating a Supplemental Enhancement Information (SEI) message that includes the syntax element.

13. The method of claim 12, wherein:
the syntax element is a first syntax element, and
the method further comprises including, in the SEI message, a second syntax element, the second syntax element specifying a value of a picture parameter set identifier for a picture parameter set referred to by the picture.

14. The method of claim 12, wherein the SEI message is a prefix SEI message that is associated with the picture.

15. The method of claim 11, wherein:
the syntax element is a first syntax element, and
generating the bitstream comprises generating the bitstream such that the bitstream includes a plurality of syntax elements that indicate whether inter-layer prediction is enabled for each tile of the picture, the plurality of syntax elements including the first syntax element.

16. The method of claim 11, wherein inter-layer prediction comprises inter-layer sample prediction.

17. The method of claim 11, wherein inter-layer prediction comprises inter-layer motion prediction.

18. The method of claim 11, wherein generating the bitstream comprises generating one or more of the following: a video parameter set (VPS) that includes the syntax element, a sequence parameter set (SPS) that includes the syntax element, a picture parameter set (PPS) that includes the syntax element, or a slice header that includes the syntax element.

19. A video decoding device comprising:
a computer-readable medium configured to store video data; and
one or more processors configured to:
obtain, from a bitstream, a syntax element;
determine, based on the syntax element, whether inter-layer prediction is enabled for decoding a tile of a picture of the video data, wherein the picture is partitioned into a plurality of tiles and the picture is not in a base layer; and
decode the tile.

20. The video decoding device of claim 19, wherein the syntax element specifies whether inter-layer prediction is enabled for the tile.

21. The video decoding device of claim 19, wherein the one or more processors are configured to obtain the syntax element from a Supplemental Enhancement Information (SEI) message of the bitstream.

22. The video decoding device of claim 21, wherein:
the syntax element is a first syntax element, and
the one or more processors are configured to obtain, from the SEI message, a second syntax element, the second syntax element specifying a value of a picture parameter set identifier for a picture parameter set referred to by the picture.

23. The video decoding device of claim 21, wherein the SEI message is a prefix SEI message that is associated with the picture.

24. The video decoding device of claim 19, wherein:
the syntax element is a first syntax element, and
the one or more processors are configured to:
obtain, from the bitstream, a plurality of syntax elements that includes the first syntax element; and
determine, based on the plurality of syntax elements, whether inter-layer prediction is enabled for each tile in the plurality of tiles of the picture.

25. The video decoding device of claim 19, wherein inter-layer prediction comprises inter-layer sample prediction.

26. The video decoding device of claim 19, wherein inter-layer prediction comprises inter-layer motion prediction.

27. The video decoding device of claim 19, wherein the one or more processors are configured to obtain the syntax element from one of: a video parameter set (VPS) of the bitstream or an extension of the VPS, a sequence parameter set (SPS) of the bitstream or an extension of the SPS, a picture parameter set (PPS) of the bitstream or an extension of the PPS, or a slice header of the bitstream or an extension of the slice header.

28. The video decoding device of claim 19, wherein the one or more processors are configured to decode the tile in parallel with a reference layer picture or tile when the tile does not use inter-layer prediction.

29. A video encoding device comprising:
a computer-readable medium configured to store video data; and
one or more processors configured to:
generate a bitstream that includes a syntax element that indicates whether inter-layer prediction is enabled for decoding a tile of a picture of the video data, wherein the picture is partitioned into a plurality of tiles and the picture is not in a base layer; and
output the bitstream.

30. The video encoding device of claim 29, wherein generating the bitstream comprises generating a Supplemental Enhancement Information (SEI) message that includes the syntax element.

31. The video encoding device of claim 30, wherein:
the syntax element is a first syntax element, and
the one or more processors are configured to include, in the SEI message, a second syntax element, the second syntax element specifying a value of a picture parameter set identifier for a picture parameter set referred to by the picture.

32. The video encoding device of claim 30, wherein the SEI message is a prefix SEI message that is associated with the picture.

33. The video encoding device of claim 29, wherein:
the syntax element is a first syntax element, and
the one or more processors are configured to generate the bitstream such that the bitstream includes a plurality of syntax elements that indicate whether inter-layer prediction is enabled for each tile of the picture, the plurality of syntax elements including the first syntax element.

34. The video encoding device of claim 29, wherein inter-layer prediction comprises inter-layer sample prediction.

35. The video encoding device of claim 29, wherein inter-layer prediction comprises inter-layer motion prediction.

36. The video encoding device of claim 29, wherein the one or more processors are configured to generate one or more of the following: a video parameter set (VPS) that includes the syntax element, a sequence parameter set (SPS) that includes the syntax element, a picture parameter set (PPS) that includes the syntax element, or a slice header that includes the syntax element.

37. A video decoding device comprising:
means for obtaining, from a bitstream, a syntax element;
means for determining, based on the syntax element, whether inter-layer prediction is enabled for decoding a tile of a picture of video data, wherein the picture is partitioned into a plurality of tiles and the picture is not in a base layer; and
means for decoding the tile.

38. The video decoding device of claim 37, wherein the syntax element specifies whether inter-layer prediction is enabled for the tile.

39. The video decoding device of claim 37, wherein obtaining the syntax element comprises obtaining the syntax element from a Supplemental Enhancement Information (SEI) message of the bitstream.

40. The video decoding device of claim 37, wherein decoding the tile comprises when the tile does not use inter-layer prediction, decoding the tile in parallel with a reference layer picture or tile.

41. A video encoding device comprising:
means for generating a bitstream that includes a syntax element that indicates whether inter-layer prediction is enabled for decoding a tile of a picture of video data, wherein the picture is partitioned into a plurality of tiles and the picture is not in a base layer; and
means for outputting the bitstream.

42. The video encoding device of claim 41, wherein generating the bitstream comprises generating a Supplemental Enhancement Information (SEI) message that includes the syntax element.

43. A computer-readable data storage medium having instructions stored thereon that, when executed, cause one or more processors to:
obtain, from a bitstream, a syntax element;
determine, based on the syntax element, whether inter-layer prediction is enabled for decoding a tile of a picture of video data, wherein the picture is partitioned into a plurality of tiles and the picture is not in a base layer; and
decode the tile.

44. A computer-readable data storage medium having instructions stored thereon that, when executed, cause one or more processors to:
generate a bitstream that includes a syntax element that indicates whether inter-layer prediction is enabled for decoding a tile of a picture of video data, wherein the picture is partitioned into a plurality of tiles and the picture is not in a base layer; and
output the bitstream.
